(19) United States
(12) Patent Application Publication
(10) Pub. No.: US 2013/0100787 A1
(43) Pub. Date: Apr. 25, 2013

(54) OPTICAL INFORMATION APPARATUS AND INFORMATION RECORDING OR REPRODUCING METHOD

(71) Applicants: Kenji Fujiune, Osaka (JP); Takeharu Yamamoto, Osaka (JP); Kenji Kondo, Osaka (JP)

(72) Inventors: Kenji Fujiune, Osaka (JP); Takeharu Yamamoto, Osaka (JP); Kenji Kondo, Osaka (JP)

(21) Appl. No.: 13/807,561

(22) PCT Filed: Apr. 25, 2012
(86) PCT No.: PCT/JP2012/002829

§ 371 Date: Dec. 28, 2012

(30) Foreign Application Priority Data
May 10, 2011 (JP) 2011-104983

(51) Int. Cl. G11B 21/10

(52) U.S. Cl. CPC G11B 21/106
USPC 369/44.14

(57) ABSTRACT

An optical head (10) focuses and irradiates a servo light beam onto at least one servo layer, and focuses and irradiates a recording/reproducing light beam onto a plurality of recording layers. An initial recording unit (20) records layer position information for specifying a position of each recording layer in advance in a predetermined position of each recording layer before recording user data in use of the recording/reproducing light beam, a layer position detection unit (21) reads layer position information in a predetermined recording layer by using the recording/reproducing light beam, and detects which one of the plurality of recording layers is the predetermined recording layer where the focal point of the recording/reproducing light beam is positioned, based on the read layer position information, and a seeking unit (22) moves the focal point of the recording/reproducing light beam to a target position based on the detected layer position.

### TECHNICAL FIELD

The present invention relates to an optical information apparatus, and information recording or reproducing method, for recording or reproducing information to/from an information carrier by irradiating a converged light beam.

### BACKGROUND ART

As an optical recording media for recording various information including video and audio, such optical disks as CD, DVD and BD (Blu-Ray Disc) are widely used. An optical disk apparatus that uses such an optical disk records or reproduces information by irradiating a light beam onto the optical disk. Therefore address information exists in each recording layer, and the focal point of the light beam is controlled on an arbitrary position by reading the address information. Furthermore, to meet the demand for even higher densities, an optical disk that has a plurality of recording layers for recording or reproducing information, where the plurality of recording layers is separated from a servo layer for controlling a position of a focal point of a light beam, has been proposed (e.g. see Patent Literature 1).

In the case of such an optical disk, a servo light beam is focused on the servo layer, and a recording and reproduction light beam is focused on a target recording layer where the information is recorded or reproduced. The two light beams are independently controlled in a direction perpendicular to the recording surface of the optical disk (hereafter called focusing direction), and the two light beams are simultaneously controlled in the radius direction of the optical disk (hereafter called tracking direction) by one track position error signal (hereafter called TE signal), which is generated based on the reflected light quantity from the servo layer. Thereby, information is recorded to or reproduced from an arbitrary recording layer out of the plurality of recording layers of the optical disk, without creating a plurality of servo layers.

In the optical disk where the servo layer and the recording layers are separated, the address information for acquiring the layer position of the recording and reproduction beam is disposed only on the servo layer. Hence the servo light beam is focused on the servo layer, and the address information is acquired using the reflected light quantity of the servo light beam.

Since the address information is limited to the servo layer, the position information in the tracking direction can be acquired. However the position information in the focusing direction of the focal point of the recording/reproducing beam, which focuses on an arbitrary recording layer independently from the focal point of the servo light beam, cannot be acquired. Therefore in the case of the conventional optical disk apparatus, it is difficult to perform an operation to seek different recording layers stably and at high-speed.

### CITATION LIST

### Patent Literature

Patent Literature 1: Japanese Patent Publication No. 3110532

### SUMMARY OF THE INVENTION

With the foregoing in view, it is an object of the present invention to provide an optical information apparatus and an information recording or reproducing method that can move a focal point of a recording/reproducing light beam from a current recording layer to a target recording layer stably at high-speed.

An optical information apparatus according to an aspect of the present invention is an optical information apparatus for recording or reproducing information to/from an information carrier provided with a plurality of recording layers on which information is recorded and at least one servo layer which is used for servo control, this apparatus including: a focused irradiation unit that focuses and irradiates a servo light bean onto at least one servo layer, and focuses and irradiates a recording/reproducing light beam onto the plurality of recording layers; a layer position information recording unit that records layer position information for specifying a position of each recording layer in a predetermined position of each recording layer in advance before recording user data, in use of the recording/reproducing light beam which is focused and irradiated by the focused irradiation unit; a layer position detection unit that reads the layer position information recorded by the layer position information recording unit in a predetermined recording layer by using the recording/reproducing light beam, and detects, based on the read layer position information, which one of the plurality of recording layer is the predetermined recording layer where the focal point of the recording/reproducing light beam is positioned; and a moving unit that moves the focal point of the recording/reproducing light beam to a target position based on the layer position detected by the layer position detection unit.

According to this configuration, the focused irradiation unit focuses and irradiates a servo light beam onto at least one servo layer, and focuses and irradiates the recording/reproducing light beam onto a plurality of recording layers. The layer position information recording unit records layer position information for specifying a position of each recording layer in a predetermined position of each recording layer in advance before recording user data, using the recording/reproducing light beam which is focused and irradiated by the focused irradiation unit. The layer position detection unit reads the layer position information recorded by the layer position information recording unit in a predetermined recording layer, using the recording/reproducing light beam, and detects, based on the read layer position information, which one of the plurality of recording layers is the predetermined recording layer, where the focal point of the recording/reproducing light beam is positioned. The moving unit moves the focal point of the recording/reproducing light beam to a target position based on the layer position detected by the layer position detection unit.

According to the present invention, the layer position information for specifying a position of each recording layer is recorded in advance in a predetermined position of each recording layer in advance before recording the user data, then based on the recorded layer position information, it is determined which one of the plurality of recording layers is the predetermined recording layer, where the focal point of the recording/reproducing light beam is positioned, and based on the detected layer position, the focal point of the recording/reproducing light beam is moved to the target position, therefore the focal point of the recording/reproducing light beam can be moved from the current recording layer to the target recording layer stably at high-speed.

The object, characteristics and advantages of the present invention will become more apparent by the detailed description and accompanying drawings hereinbelow.

### BRIEF DESCRIPTION OF THE DRAWINGS

FIG. 1 is a block diagram depicting a configuration of an optical disk apparatus according to Embodiment 1 of the present invention.

FIG. 2 is an example of a servo layer and a plurality of recording layers of an optical disk when initial recording operation is performed.

FIG. 3 is an example of a moving pattern of a focal point of a recording/reproducing light beam upon seeking.

FIG. 4A is an example of a positional relationship between a focal point of a servo light beam and the focal point of the recording/reproducing light beam when the optical disk has no relative tilt, and FIG. 4B is an example of a positional relationship between the focal point of the servo light beam and the focal point of the recording/reproducing light beam when the optical disk has a relative tilt.

FIG. 5 is a block diagram depicting a configuration of an optical disk apparatus according to a modification of Embodiment 1.

FIG. 6 is a block diagram depicting a configuration of an optical disk apparatus for recording layer position information according to Embodiment 2 of the present invention.

FIG. 7 is a block diagram depicting a configuration of an optical disk apparatus for moving the recording/reproducing light beam according to Embodiment 2 of the present invention.

FIG. 8A is an example of a signal that is outputted from a TE detection unit when the recording/reproducing light beam is focused on the servo layer, and FIG. 8B is an example of a signal that is outputted from the TE detection unit when the recording/reproducing light beam is focused on the recording layer.

FIG. 9 is an example of a moving pattern when the recording/reproducing light beam moves to another recording layer.

FIG. 10 is a block diagram depicting a configuration of an optical disk according to a modification of Embodiment 2 of the present invention.

FIG. 11 is an example of a focus error signal detected by an FE detection unit, and a moving pattern when the recording/reproducing light beam moves to another recording layer.

FIG. 12 is a block diagram depicting a configuration of an optical disk apparatus according to Embodiment 3 of the present invention.

FIG. 13 is an example of a recording state of each recording layer of an optical disk.

FIG. 14 is a block diagram depicting a configuration of an optical disk apparatus according to Embodiment 4 of the present invention.

### DESCRIPTION OF EMBODIMENTS

Embodiments of the present invention will now be described with reference to the drawings. The following embodiments are examples to carry out the present invention, and are not intended to limit the technical scope of the present invention.

### Embodiment 1

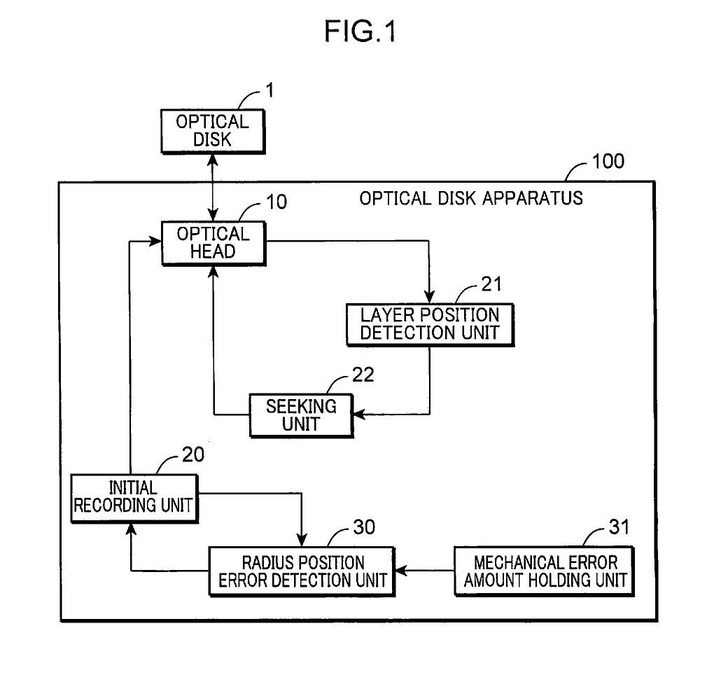

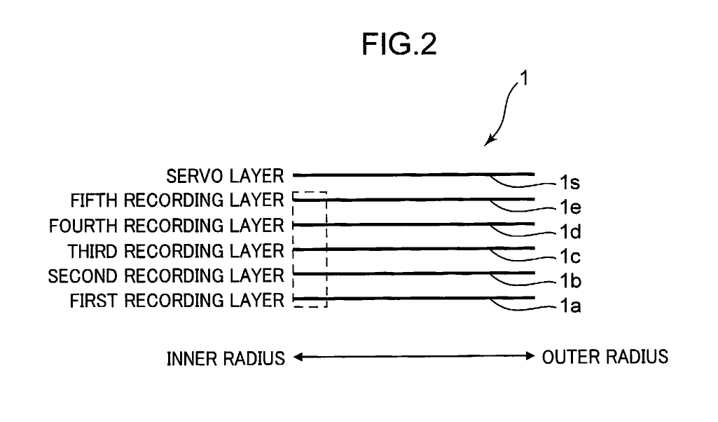

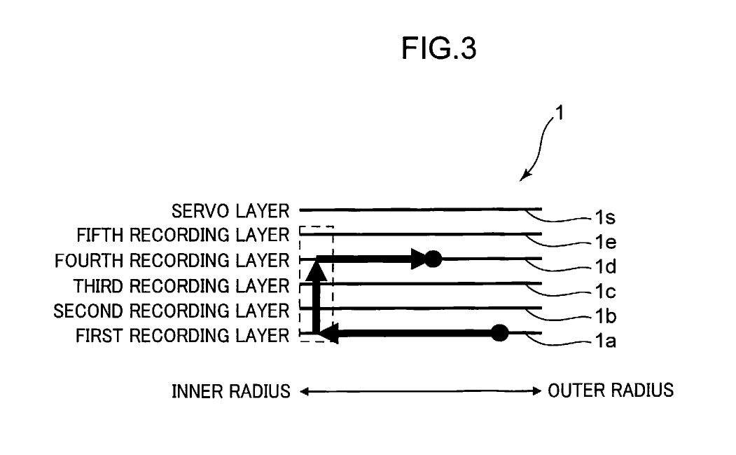

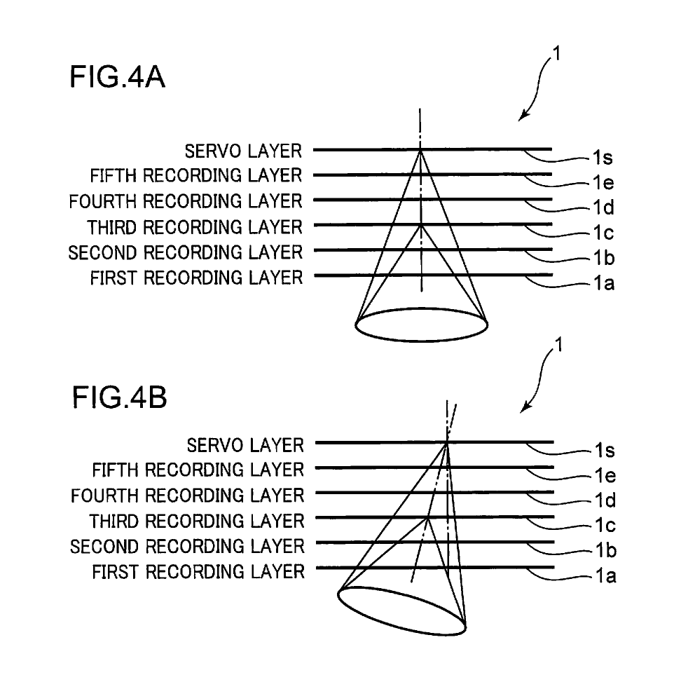

An operation of an optical disk apparatus according to Embodiment 1 will be described with reference to FIG. 1, FIG. 2, FIG. 3, FIG. 4A and FIG. 4B. FIG. 1 is a block diagram depicting a configuration of the optical disk apparatus according to Embodiment 1 of the present invention.

FIG. 2 is an example of a servo layer and a plurality of recording layers when an initial recording operation is performed. FIG. 3 is an example of a moving pattern of a focal point of a recording/reproducing light beam upon seeking. FIG. 4A is an example of a positional relationship between a focal point of a servo light beam and the focal point of the recording/reproducing light beam when the optical disk has no relative tilt. FIG. 4B is an example of a positional relationship between the focal point of the servo light beam and the focal point of the recording/reproducing light beam when the optical disk has a relative tilt.

The optical disk apparatus 100 shown in FIG. 1 comprises an optical head 10, an initial recording unit 20, a layer position detection unit 21, a seeking unit 22, a radius position error detection unit 30 and a mechanical error amount holding unit 31.

In FIG. 1, the optical disk apparatus 100 corresponds to an example of the optical information apparatus, the optical head 10 corresponds to an example of the focused irradiation unit, the initial recording unit 20 corresponds to an example of the layer position information recording unit, the layer position detection unit 21 corresponds to an example of the layer position detection unit, the seeking unit 22 corresponds to an example of the moving unit, the radius position error detection unit 30 corresponds to an example of the radius position error detection unit, and the mechanical error amount holding unit 31 corresponds to an example of the mechanical error amount holding unit.

The optical disk 1 is provided with a plurality of recording layers on which information is recorded, and at least one servo layer which is used for servo control. For example, as FIG. 2 shows, the optical disk 1 is provided with first to fifth recording layers 1a to 1e and a servo layer 1s. In FIG. 2, the optical disk 1 has five recording layers, but the present invention is not limited to this configuration, and may have two recording layers, three recording layers, four recording layers or six or more recording layers, that is, it is sufficient if the optical disk 1 has a plurality of recording layers. In FIG. 2, the optical disk 1 has one servo layer, but the present invention is not limited to this, and may have two or more servo layers, that is, it is sufficient if the optical disk 1 has at least one servo layer.

The optical head 10 focuses and irradiates a servo light beam onto at least one servo layer, and focuses and irradiates the recording/reproducing light beam onto the plurality of recording layers. The optical head 10 focuses and irradiates the recording/reproducing light beam onto an arbitrary recording layer and arbitrary radius position of the optical disk 1 at arbitrary power. The optical head 10 transmits a light quantity signal to the layer position detection unit 21 based on a reflected light quantity from the optical disk 1.

The optical head 10 comprises a recording/reproducing light source that emits a recording/reproducing light beam, a servo light source that emits a servo light beam, a first collimate lens that converts the recording/reproducing light beam emitted by the recording/reproducing light source into an approximately parallel light, a second collimate lens that converts the servo light beam emitted by the servo light source into an approximately parallel light, an objective lens that focuses the recording/reproducing light beam onto one of the plurality of recording layers and focuses the servo light beam onto at least one servo layer, a beam splitter that matches the optical axis of the recording/reproducing light beam which was converted into the approximately parallel light by the first collimate lens, and the optical axis of the servo light beam which was converted into the approximately parallel light by the second collimate lens, and guides the recording/reproducing light beam and the servo light beam to the objective lens, an objective lens actuator that moves the objective lens in the optical axis direction, and moves the focal point of the recording/reproducing light beam to the recording layer, and a collimate lens actuator that moves the second collimate lens in the optical axis direction and moves a focal point of the servo light beam to the servo layer.

For the optical head 10, a recording/reproducing apparatus disclosed in Japanese Patent Application Laid-Open No. 2005-317180 is used.

The initial recording unit 20 records layer position information for specifying a position of each recording layer in a predetermined position of each recording layer in advance before recording user data, using the recording/reproducing light beam which is focused and irradiated by the optical head 10.

For example, the respective layer position information for the first to fifth recording layers 1a to 1e may be continuous numeric characters “0”, “1”, “2”, “3” and “4”. Alternatively, the respective layer position information for the first to fifth recording layers 1a to 1e may be continuous numerical characters “4”, “3”, “2”, “1” and “0”. The layer position information need not be continuous numeric characters. For example, the respective layer position information for the first to fifth recording layers 1a to 1e may be unique numbers which are different from one another.

The layer position detection unit 21 reads, using the recording/reproducing light beam, the layer position information recorded by the initial recording unit 20 in a predetermined recording layer, and detects, based on the read layer position information, which one of the plurality of recording layers is the predetermined recording layer, where the focal point of the recording/reproducing light beam is positioned. Based on the light quantity signal received from the optical head 10, the layer position detection unit 21 detects which recording layer of the optical disk 1 the focal point of the recording/reproducing light beam is positioned, and transmits the layer position information to the seeking unit 22.

Based on the layer position detected by the layer position detection unit 21, the seeking unit 22 moves the focal point of the recording/reproducing light beam to the target position. Based on the layer position information from the layer position detection unit 21, the seeking unit 22 transmits a driving signal to the optical head 10, so as to seek the target recording layer for the focal point of the recording/reproducing light beam to be positioned. The optical head 10 moves the position of the focal point of the recording/reproducing light beam based on the driving signal from the seeking unit 22.

The radius position error detection unit 30 detects an error of the position of the recording/reproducing light beam in the radius direction. Based on the error detected by the radius position error detection unit 30, the initial recording unit 20 determines a width of the recording area in the tracking direction, in order to record the layer position information in the predetermined position of each recording layer in advance.

For example, by changing the recording amount of the layer position information according to the error detected by the radius position error detection unit 30, the initial recording unit 20 changes the recording area in the tracking direction for recording the layer position information in advance. If the recording amount of the layer position information increases, the width of the recording area in the tracking direction for recording the layer position information in advance increases, and if the recording amount of the layer position information decreases, the width of the recording area in the tracking direction for recording the layer position information in advance decreases. The initial recording unit 20 can change the recording amount by changing a number of times of recording information including the layer position information having a same content.

The mechanical error amount holding unit 31 holds a mechanical error amount which is generated when the focal point of the recording/reproducing light beam is moved in the radius direction. Based on the error amount held in the mechanical error amount holding unit 31, the radius position error detection unit 30 detects an error of the position of the recording/reproducing light beam in the radius direction.

The mechanical error amount holding unit 31 also holds a mechanical error amount which is generated when the optical head 10 is moved in the tracking direction, and transmits the data to the radius position error detection unit 30. Based on the mechanical error amount from the mechanical error amount holding unit 31, the radius position error detection unit 30 transmits the radius position error amount to the initial recording unit 20. In other words, the radius position error detection unit 30 reads the mechanical error amount from the mechanical error amount holding unit 31, and transmits the read mechanical error amount to the initial recording unit 20 as a radius position error amount. If the optical disk 1 is started up in the optical disk apparatus for the first time, the initial recording unit 20 changes the position of the focal point and power of the optical head 10, and records information including the layer position information for each recording layer of the optical disk 1, in a recording area corresponding to the radius position amount of not less than the radius position error amount from the radius position error detection unit 30. In the present description, the operation to record the information including the layer position information in a recording layer of the optical disk is called the “initial recording operation”.

The initial recording unit 20 includes the layer position information in the data to be recorded, and performs the initial recording operation of the data that includes the layer position information. The recorded data is stored in the optical disk 1. Therefore the initial recording operation need not be performed for a plurality of times for one optical disk 1. When the optical disk 1 is started up, the optical disk apparatus 100 reads control data recorded in the optical disk 1, and checks if the initial recording operation has been performed. Only if the initial recording operation has not been performed, the initial recording unit 20 performs the initial recording operation, and writes in the control data of the optical disk 1 that the initial recording operation has been performed. Thereby the initial recording operation can be performed only once for one optical disk 1.

If the optical disk 1 has one servo layer, the spiral direction of the tracks created in the servo layer is constant. This means that the first recording position in each recording layer is an innermost radius or an outermost radius. If the width in the tracking direction of the data recorded in the initial recording operation is narrow, positioning of the recording/reproducing light beam on the recording area is difficult when seeking by the seeking unit 22. Hence the width in the tracking direction of a recording area, where the data including the layer position information is recorded, must exceed the mechanical error generated during the seeking operation in the tracking direction. The mechanical error does not change for each recording layer, so the width of the recording area in the tracking direction, where data is recorded in the initial recording operation, is the same for all the recording layers. For a concrete example, the initial recording unit 20 records the layer position information in the recording start position on the innermost radius side enclosed by the broken line, as shown in FIG. 2 for all the recording layers except the servo layer, so as to have a width detected by the radius position error detection unit 30 based on the mechanical error in the radius direction, which is held by the mechanical error amount holding unit 31.

Further, as FIG. 2 shows, the initial recording unit 20 records the layer position information in a same radius position of each recording layer in advance. The seeking unit 22 moves the focal point of the recording/reproducing light beam to a target recording layer in a radius position where the initial recording unit 20 recorded the layer position information.

The seeking operation is performed for the recording operation or reproducing operation, which is performed after the seeking operation. In the case of performing the reproducing operation, the target position can be sought by reading the position information that is recorded with the user data. In the case of performing the recording operation, the data including the position information is recorded in the first recording position in each recording layer by the initial recording operation, so the point immediately before the target position can be sought by reading the position information. Furthermore, in a predetermined radius position, data including the layer position information has been recorded in all the recording layers by the initial recording operation performed by the initial recording unit 20. Therefore when the seeking unit 22 performs the seeking operation from the current recording layer to an arbitrary target recording layer, the optical head 10 reads the recorded layer position information using the focal point of the recording/reproducing light beam, whereby the focal point of the recording/reproducing light beam can be moved to the target recording layer stably at high-speed.

An example of the seeking operation will be described in detail with reference to FIG. 3. To move the focal point of the recording/reproducing light beam from an outer radius position of the first recording layer 1a to an intermediate radius position of the fourth recording layer 1d, the seeking unit 22 first moves the focal point of the recording/reproducing light beam in the tracking direction to the radius position where the layer position information is recorded in the first recording layer 1a. In this case, the recording area where the layer position information is recorded has a width considering a mechanical error in the tracking direction. Therefore the seeking unit 22 can reach the focal point of the recording/reproducing light beam to reach the target position stably at high-speed.

Then the layer position detection unit 21 reads the layer position information, which was recorded in the current recording layer by the initial recording unit 20, using the recording/reproducing light beam, and detects, based on the read layer position information, which one of the plurality of recording layers is the current recording layer, where the focal point of the recording/reproducing light beam is positioned.

Then the seeking unit 22 moves the focal point of the recording/reproducing light beam in the focusing direction from the first recording layer 1a to the fourth recording layer 1d. In this case, the focal point of the recording/reproducing light beam moves through the radius position where the initial recording operation was performed. Therefore the layer position detection unit 21 can always acquire the current layer position information, and allow the focal point of the recording/reproducing light beam to reach the target position stably at high-speed.

Finally, the seeking unit 22 moves the focal point of the recording/reproducing light beam in the tracking direction, from the radius position, where the layer position information was recorded by the initial recording unit 20 in the fourth recording layer 1d, to a target intermediate radius position.

Since the layer position information is recorded like this in the first recording position of each recording layer on the optical disk 1, from which the layer position information cannot be acquired in an unrecorded status, the seeking operation can be implemented stably at high-speed.

In Embodiment 1, the layer position detection unit 21 reads control data to detect whether the initial recording operation has been performed, but the present invention is not limited to this configuration. The layer position detection unit 21 may actually move the focal point of the recording/reproducing light beam to an area where the layer position information is recorded, and determine whether the layer position information has been recorded, based on the change of the detected reproduction signal. Furthermore, the layer position detection unit 21 may determine whether the layer position information has been recorded based on the detection result of all the recording layers, or based on the detection result of one of the plurality of recording layers.

In Embodiment 1, the initial recording unit 20 records the layer position information in a predetermined position of each recording layer when the optical disk 1 is first started up by the optical disk apparatus 100, but the present invention is not limited to this configuration. The initial recording unit 20 may record the layer position information in a predetermined position of each recording layer when the optical disk 1 is shipped. Instead, the initial recording unit 20 may record the layer position information in a predetermined position of each recording layer when the user data is recorded in the optical disk 1 by the optical disk apparatus 100 for the first time.

In Embodiment 1, the initial recording unit 20 records the layer position information all at once for all the recording layers, but the present invention is not limited to this configuration. For example, if the recording layers are sequentially used one-by-one, the initial recording unit 20 may perform the initial recording operation only for recording layers where recording is performed for the first time. In other words, the initial recording unit 20 may record the layer position information in a predetermined position of one of the plurality of recording layers of the optical disk 1 if user data is recorded in this recording layer for the first time.

In Embodiment 1, the initial recording unit 20 determines the width in the tracking direction of the recording area where the layer position information is recorded based on the mechanical error, but the present invention is not limited to this configuration. The initial recording unit 20 may determine the width in the tracking direction of the recording area where the layer position information is recorded, based on the eccentricity of the optical disk 1 or a difference of eccentricity values of each recording layer. In this case, the optical disk apparatus has a storing unit that stores an eccentricity of the optical disk 1 or a difference of eccentricity values of each recording layer in advance. The radius position error detection unit 30 reads the eccentricity of the optical disk 1 or the difference of eccentricity values of each recording layer from the storing unit, and then initial recording unit 20 determines the width in the tracking direction of the recording area where the layer position information is recorded according to the eccentricity of the optical disk 1 or the difference of eccentricity values of each recording layer, which was read by the radius position error detection unit 30.

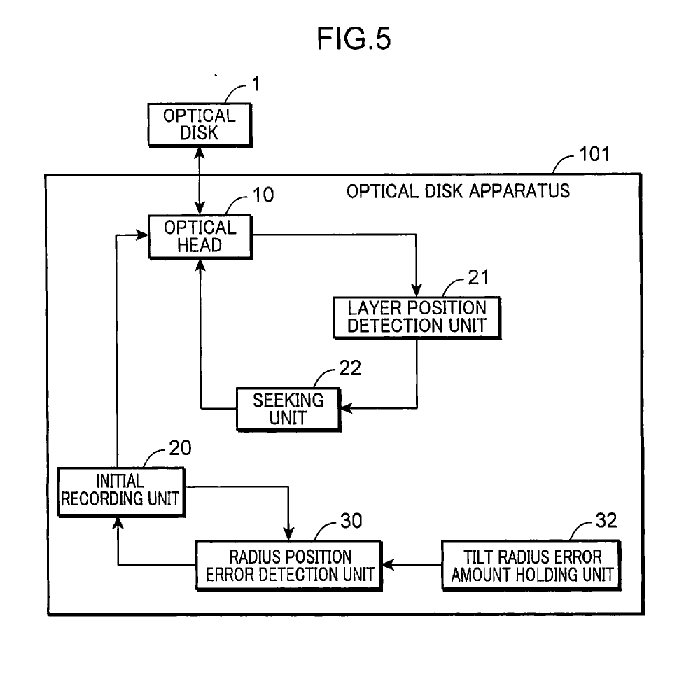

Alternatively the initial recording unit 20 may determine the width in the tracking direction of the recording area where the layer position information is recorded, based on the displacement of the focal point of the recording/reproducing light beam generated by a tilt of the lens of the optical head 10 or the optical disk 1. FIG. 4A is a diagram depicting the position of the servo light beam in the radius direction and the position of the recording/reproducing light beam in the radius direction when the optical axis of the recording/reproducing light beam is not perpendicular to the surface of the optical disk, and FIG. 4B is a diagram depicting the position of the servo light beam in the radius direction and the position of the recording/reproducing light beam in the radius direction when the optical axis of the recording/reproducing light beam is perpendicular to the surface of the optical disk. FIG. 5 is a block diagram depicting a configuration of an optical disk apparatus according to a modification of Embodiment 1.

If the lens of the optical head 10 or the optical disk 1 is not tilted, the optical axis of the recording/reproducing light beam is perpendicular to the surface of the optical disk. If the lens of the optical head 10 or the optical disk 1 is tilted, on the other hand, the optical axis of the recording/reproducing light beam no longer becomes perpendicular to the surface of the optical disk. The optical axis of the recording/reproducing light beam and the optical axis of the servo light beam, however, are matched.

Now the displacement of the focal point of the recording/reproducing light beam generated by a tilt will be described in detail with reference to FIG. 4A and FIG. 4B. As FIG. 4A shows, the focal point of the servo light beam with respect to the optical disk 1 is in the servo layer 1s, and the focal point of the recording/reproducing light beam is in the third recording layer 1c. In this case, the lens of the optical head 10 or the optical disk 1 is not tilted, hence the focal point of the servo light beam and the focal point of the recording/reproducing light beam exist in a same radius position. If the lens of the optical head 10 or the optical disk 1 is tilted as shown in FIG. 4B, however, the focal point of the servo light beam and the focal point of the recording/reproducing light beam exist in different radius positions. The position in the tracking direction of the focal point of the recording/reproducing light beam is controlled using the focal point of the servo light beam focused on the servo layer 1s, therefore the displacement in the tracking direction of the focal point of the recording/reproducing light beam becomes an error of the position in the tracking direction of the focal point of the recording/reproducing light beam.

This means that the radius position error detection unit 30 may detect an error of the position in the radius direction of the recording/reproducing light beam generated by the relative tilt between the optical axis of the recording/reproducing light beam and the optical disk.

An optical disk apparatus 101 shown in FIG. 5 comprises an optical head 10, an initial recording unit 20, a layer position detection unit 21, a seeking unit 22, a radius position error detection unit 30 and a tilt radius error amount holding unit 32. In FIG. 5, a composing element the same as the optical disk apparatus 100 in FIG. 1 is denoted with a same reference number, for which detailed description is omitted.

The tilt radius error amount holding unit 32 holds an error amount of the focal point of the recording/reproducing light beam in the radius direction, which is generated by a relative tilt between the optical axis of the recording/reproducing light beam which is parallel with the optical axis of the servo light beam and the optical disk 1, in a state where the focal point of the servo light beam is controlled to be positioned on a predetermined track of the servo layer 1s.

The radius position error detection unit 30 detects an error of the position of the recording/reproducing light beam in the radius direction based on the error amount held in the tilt radius error amount holding unit 32.

In this way, the layer position information can be recorded considering the error amount of the focal position of the recording/reproducing light beam in the radius direction generated by a relative tilt between the optical axis of the recording/reproducing light beam and the optical disk 1.

In this embodiment, the optical axis of the recording/reproducing light beam and the optical axis of the servo light beam match, but the present invention is not limited to this configuration, and the optical axis of the recording/reproducing light beam and the optical axis of the servo light beam may be parallel with each other.

In Embodiment 1, the radius position error detection unit 30 detects an error of the position of the recording/reproducing light beam in the radius direction, that commonly exists in all the recording layers, and the width of the recording area in the tracking direction for recording the layer position information in advance is the same for all the recording layers, but the present invention is not limited to this configuration. The radius position error detection unit 30 may detect an error of the position of the recording/reproducing light beam in the radius direction for each recording layer, and the width of the recording area in the tracking direction for recording the layer position information in advance may be different depending on the recording layer.

In Embodiment 1, the initial recording unit 20 records the layer position information only in the first recording position of each recording layer when the initial recording operation is performed, but the layer position information may be recorded in a plurality of radius positions in each recording layer in advance, so that a faster seeking is implemented.

In this embodiment, the initial recording unit 20 records information including the layer position information in the recording start position of each recording layer in advance, using the recording/reproducing light beam, before the user data is recorded. However the position where the layer position information is recorded is not limited to the recording start position. The initial recording unit 20 may record the information including the layer position information in a predetermined position of each recording layer in advance, using the recording/reproducing light beam, before the user data is recorded. For example, the position where the layer position information is recorded may be an inner radius area on the optical disk 1, or an outer radius area on the optical disk 1, or a predetermined position in the user data recording area on the optical disk 1.

The position where the layer position information is recorded is not limited to one location in each recording layer, but may be recorded in a plurality of positions in each recording layer.

### Embodiment 2

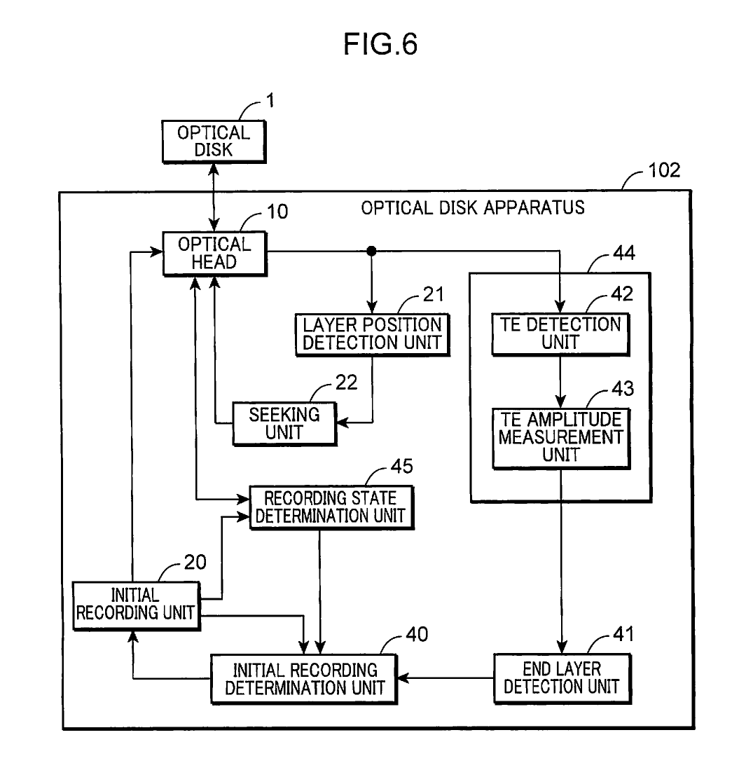

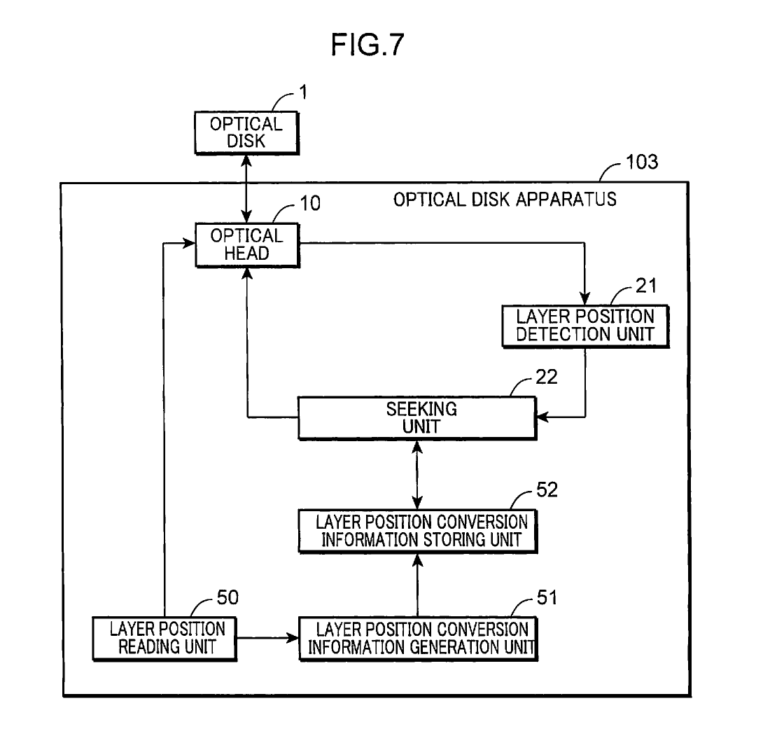

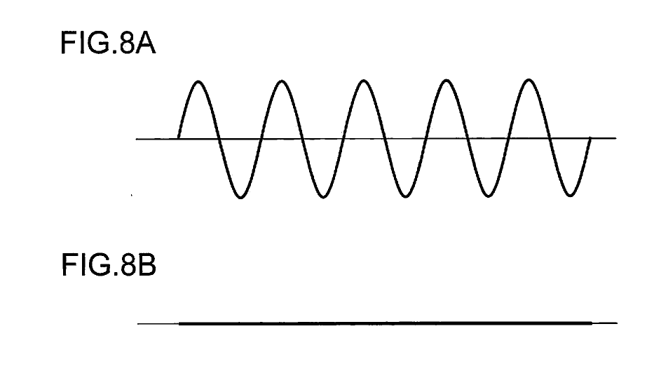

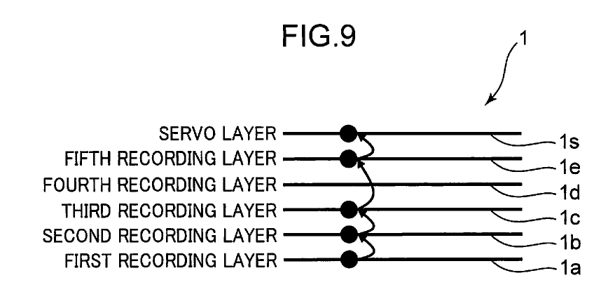

An optical disk apparatus according to Embodiment 2 of the present invention will be described with reference to FIG. 6, FIG. 7, FIG. 8A, FIG. 8B and FIG. 9. FIG. 6 is a block diagram depicting a configuration of an optical disk apparatus for recording layer position information according to Embodiment 2 of the present invention. FIG. 7 is a block diagram depicting a configuration of an optical disk apparatus for moving the recording/reproducing light beam according to Embodiment 2 of the present invention. FIG. 8A is an example of a signal that is outputted from a TE detection unit 42 when the recording/reproducing light beam is focused on the servo layer. FIG. 8B is an example of a signal that is outputted from the TE detection unit 42 when the recording/reproducing light beam is focused on the recording layer. FIG. 9 is an example of a moving pattern when the recording/reproducing light beam moves to another recording layer.

In FIG. 6 and FIG. 7, an optical disk apparatus 102 corresponds to an example of the optical information apparatus, an optical head 10 corresponds to an example of the focused irradiation unit, an initial recording unit 20 corresponds to an example of the layer position information recording unit, a layer position detection unit 21 corresponds to an example of the layer position detection unit, a seeking unit 22 corresponds to an example of the moving unit, an initial recording determination unit 40 corresponds to an example of the layer position information recording determination unit, an end layer detection unit 41 corresponds to an example of the end layer detection unit, a servo layer determination unit 44 corresponds to an example of the servo layer determination unit, a recording state determination unit 45 corresponds to an example of the recording state determination unit, a layer position reading unit 50 corresponds to an example of the layer position reading unit, and a layer position conversion information generation unit 51 corresponds to an example of the layer position conversion information generation unit.

In FIG. 6 and FIG. 7, a composing element the same as a composing element of Embodiment 1 shown in FIG. 1 is denoted with a same reference number, for which description is omitted.

The optical disk apparatus 102 shown in FIG. 6 comprises the optical head 10, the initial recording unit 20, the layer position detection unit 21, the seeking unit 22, the initial recording determination unit 40, the end layer detection unit 41, the servo layer determination unit 44 and the recording state determination unit 45.

The initial recording determination unit 40 determines whether there is a recording layer where the layer position information is not recorded by the initial recording unit 20. If the initial recording determination unit 40 determines that there is a recording layer where the layer position information is not recorded, the initial recording unit 20 records the layer position information again in a predetermined position of the recording layer where the layer position information is not recorded.

The end layer detection unit 41 detects that the focal point of the recording/reproducing light beam exceeded an upper end recording layer or a lower end recording layer of the plurality of recording layers. When the initial recording unit 20 records the layer position information in the upper end recording layer or the lower end recording layer, the initial recording determination unit 40 determines that there is a recording layer where the layer position information is not recorded if the end layer detection unit 41 detects that the focal point of the recording/reproducing light beam exceeded the upper end recording layer or the lower end recording layer of the plurality of recording layers before reaching the target recording layer.

Control data, which is recorded in the optical disk 1 in advance, includes information that indicates a number of recording layers. Therefore by the optical head 10 reading the control data, the initial recording determination unit 40 can know a number of recording layers of the optical disk 1, mounted in the optical disk apparatus 102, in advance. The initial recording determination unit 40 determines that there is a recording layer where the layer position information is not recorded if the end layer detection unit 41 detects that the focal point of the recording/reproducing light beam exceeded the upper end recording layer or the lower end recording layer of the plurality of recording layers before reaching a number of recording layers that is known in advance.

The servo layer determination unit 44 determines whether the focal point of the recording/reproducing light beam is in the recording layer or the servo layer based on the reflected light quantity. If the servo layer determination unit 44 determined that the focal point of the recording/reproducing light beam is in the servo layer, the end layer detection unit 41 detects that the focal point of the recording/reproducing light beam exceeded the upper end recording layer or the lower end recording layer of the plurality of recording layers.

The servo layer determination unit 44 has a TE detection unit 42 and a TE amplitude measurement unit 43.

Based on the light quantity signal from the optical head 10, the TE detection unit 42 generates a tracking error signal (hereafter called TE signal) according to the distance between the focal point of the recording/reproducing light beam and the track center, and transmits the generated TE signal to the TE amplitude measurement unit 43. The TE amplitude measurement unit 43 measures the amplitude of the TE signal received from the TE detection unit 42, and transmits the amplitude of the measured TE signal to the end layer detection unit 41.

The end layer detection unit 41 compares the amplitude of the TE signal received from the TE amplitude measurement unit 43 and a predetermined value. If the amplitude of the TE signal received from the TE amplitude measurement unit 43 is greater than the predetermined value, the end layer detection unit 41 determines that the focal point of the recording/reproducing light beam is in the servo layer, that is, determines that the focal point of the recording/reproducing light beam exceeded the upper end recording layer or the lower end recording layer of the plurality of recording layers, and transmits the determination result of the initial recording determination unit 40.

If the amplitude of the TE signal received from the TE amplitude measurement unit 43 is the predetermined value or less, on the other hand, the end layer detection unit 41 determines that the focal point of the recording/reproducing light beam is in one of the plurality of recording layers, that is, determines that the focal point of the recording/reproducing light beam does not exceed the upper end recording layer or the lower end recording layer of the plurality of recording layers, and transmits the determination result to the initial recording determination unit 40.

The initial recording unit 20 transmits a signal to indicate whether the initial recording operation to record the layer position information is in-execution to the initial recording determination unit 40. If the determination result received from the end layer detection unit 41 indicates that the focal point of the recording/reproducing light beam does not exist in the recording layer while receiving a signal that indicates the initial recording operation is in-execution from the initial recording unit 20, the initial recording determination unit 40 determines that an initial recording operation abnormality occurred, and transmits the determination result to the initial recording unit 20.

If the signal to indicate that the initial recording operation is not in-execution is received from the initial recording unit 20, or if the determination result received from the end layer detection unit 41 indicates that the focal point of the recording/reproducing light beam exists in the recording layer while receiving the signal to indicate that the initial recording operation is in-execution from the initial recording unit 20, the initial recording determination unit 40 determines that the initial recording operation is not abnormal, and transmits the determination result to the initial recording unit 20.

If the determination result from the initial recording determination unit 40 indicates that the initial recording operation is abnormal, the initial recording unit 20 seeks a recording layer where the layer position information is not recorded, and records the layer position information again in this recording layer.

After the initial recording unit 20 recorded the layer position information in each recording layer in advance, the recording state determination unit 45 focuses and irradiates the recording/reproducing light beam to all of the plurality of recording layers respectively, and determines whether each recording layer is in a recorded state or in an unrecorded state based on the reflected light quantity from each recording layer. If the recording state determination unit 45 determines that at least one recording layer is in an unrecorded state, the initial recording determination unit 40 determines that there is a recording layer where the layer position information is not recorded.

In other words, if the initial recording operation to record the layer position information ends, the initial recording unit 20 transmits a signal to indicate the end of the initial recording operation to the recording state determination unit 45. If the signal to indicate the end of the initial recording operation is received from the initial recording unit 20, the recording state determination unit 45 causes the optical head 10 to focus and irradiate the recording/reproducing light beam to all of the plurality of recording layers respectively.

Based on the light quantity signal received from the optical head 10, the recording state determination unit 45 determines whether the recording state is a recorded state or an unrecorded state for each recording layer, and transmits the determination result to the initial recording determination unit 40. If at least one recording layer is in an unrecorded state in the determination result received from the recording state determination unit 45, the initial recording determination unit 40 determines that the initial recording operation is abnormal, and transmits the determination result to the initial recording unit 20. If the determination result received from the initial recording determination unit 40 indicates that the initial recording operation is abnormal, the initial recording unit 20 seeks a recording layer where the layer position information is not recorded, and records the layer position information again in this recording layer.

The optical disk apparatus 103 shown in FIG. 7 comprises the optical head 10, the layer position detection unit 21, the seeking unit 22, the layer position reading unit 50, the layer position conversion information generation unit 51 and the layer position conversion information storing unit 52. In this embodiment, the optical disk apparatus 102 and the optical disk apparatus 103 are separately illustrated, but the optical disk apparatus may comprise the composing elements of the optical disk apparatus 102 and the composing elements of the optical disk apparatus 103.

The layer position reading unit 50 reads the layer position information, which was recorded in each recording layer by the initial recording unit 20. The layer position conversion information generation unit 51 generates layer position conversion information in which the layer position information read by the layer position reading unit 50 and an actual position of the recording layer are corresponded. The layer position conversion information storing unit 52 stores the layer position conversion information generated by the layer position conversion information generation unit 51. The seeking unit 22 converts the layer position information detected by the layer position detection unit 21 into an actual position of the recording layer using the layer position conversion information generated by the layer position conversion information generation unit 51, and moves the focal point of the recording/reproducing light beam to the target recording layer.

After the initial recording operation ends normally, the layer position reading unit 50 reads the layer position information recorded in each recording layer in the initial recording operation, and transmits the read layer position information to the layer position conversion information generation unit 51. The layer position conversion information generation unit 51 generates a table (layer position conversion information) that indicates a relationship between layer position information received from the layer position reading unit 50 and an actual position of the recording layer, and stores the generated table in the layer position conversion information storing unit 52. Using the table stored in the layer position conversion information storing unit 52, the seeking unit 22 converts a position of the recording layer specified by the layer position information received from the layer position detection unit 21 into an actual position of the recording layer, generates a driving signal to move the recording/reproducing light beam to the target recording layer, and transmits the driving signal to the optical head 10.

The initial recording operation to record the layer position information will now be described with reference to FIG. 9. In the initial recording operation, the layer position information is recorded sequentially for the first recording layer 1a to the fifth recording layer 1e. In the stage of the initial recording operation, there is a recording layer where the layer position information is not recorded, hence in some cases, the layer position information cannot be acquired from the layer position detection unit 21. This means that when the focal point of the recording/reproducing light beam is moved from the third recording layer 1c to the fourth recording layer 1d, for example, the initial recording unit 20 may move the focal point from the third recording layer 1c to the fifth recording layer 1e in error. In this case, the initial recording unit 20 records the layer position information, to indicate the fourth recording layer 1d, in the fifth recording layer 1e. Then the initial recording unit 20 moves the focal point of the recording/reproducing light beam to the servo layer 1s, so that the focal point of the recording/reproducing light beam will move to the fifth recording layer 1e.

Detection of such an abnormal state as the above case and recovery from the abnormality state will be described with reference to FIG. 8A and FIG. 8B. The servo layer 1s of the optical disk 1 has a track in order to control the position of the focal point of the servo light beam in the tracking direction. However a track does not exist in the first to fifth recording layers 1a to 1e of the optical disk 1, since the position of the focal point of the recording/reproducing light beam in the tracking direction is controlled by being synchronized with the focal point of the servo light beam. The TE detection unit 42 generates a TE signal according to the change of the light quantity signal received from the optical head 10, which is generated by the groove of the track.

In the servo layer 1s that has a track, the TE signal having a predetermined amplitude is detected as shown in FIG. 8A, but in the first to fifth recording layers 1a to 1e that have no track, the TE signal is not detected as shown in FIG. 8B. Using this characteristic, the TE amplitude measurement unit 43 measures the amplitude of the TE signal that is generated by the TE detection unit 42 based on the reflected light quantity of the recording/reproducing light beam. Thereby the end layer detection unit 41 can determine whether the focal point of the recording/reproducing light beam is in the recording layer or in the servo layer.

As FIG. 9 shows, the layer position information is not recorded in the fourth recording layer 1d when the initial recording operation is performed, and it can be determined that there is a recording layer where the layer position information is not recorded, if a number of recording layers, where the layer position information is recorded by the time when the focal point of the recording/reproducing light beam reaches the servo layer 1s, is four. By sequentially seeking whether the layer position information is recorded or not for the fifth recording layer 1e to the first recording layer 1a, the initial recording unit 20 can detect that the fourth recording layer 1d is in an unrecorded state. Hence the initial recording unit 20 records the layer position information again in the fourth recording layer 1d.

In this case, in the stage of recording the layer position information in the fifth recording layer 1e, the layer position information that indicates the fourth recording layer 1d is recorded in the fifth recording layer 1e. Therefore if the layer position information that indicates the fourth recording layer 1d is used again in the stage of recording the layer position information in the fourth recording layer 1d, the same layer position information is recorded in the two recording layers. To prevent this, the initial recording unit 20 records the layer position information that indicates the fifth recording layer 1e, which is not in use, when the layer position information is recorded in the fourth recording layer 1d again.

This allows recording different layer position information in each recording layer. However the layer position information recorded in the fourth recording layer 1d and the layer position information recorded in the fifth recording layer 1e are switched. Therefore the layer position reading unit 50 reads the layer position information in all the recording layers where the layer position information is recorded, and detects that the layer position information recorded in the fourth recording layer 1d and the layer position information recorded in the fifth recording layer 1e are switched, and transmits this information to the layer position conversion information generation unit 51. The layer position conversion information generation unit 51 generates a conversion table where the layer position information recorded in the fourth recording layer 1d is corresponded with the fifth recording layer 1e, and the layer position information recorded in the fifth recording layer 1e is corresponded with the fourth recording layer 1d, and stores the conversion table in the layer position conversion information storing unit 52.

If the layer position information that indicates the fourth recording layer 1d is acquired from the layer position detection unit 21, the seeking unit 22 converts this layer position information into the layer position information that indicates the fifth recording layer 1e using the conversion table stored in the layer position conversion information storing unit 52. If the layer position information that indicates the fifth recording layer 1e is acquired from the layer position detection unit 21, the seeking unit 22 converts this layer position information into the layer position information that indicates the fourth recording layer 1d. Thereby the focal point of the recording/reproducing light beam can be moved to the target recording layer.

Thus the recording/reproducing light beam can be moved stably at high-speed, even if the layer position information is recorded in a different recording layer outside the recording layer where the information should be recorded, and there is a recording layer where the layer position information is not recorded in the first recording operation.

In Embodiment 2, the end layer detection unit 41 detects that the focal point of the recording/reproducing light beam is in the servo layer based on the amplitude of the TE signal, but the present invention is not limited to this configuration, and the end layer detection unit 41 may detect that the focal point of the recording/reproducing light beam is in the servo layer using address information which is read based on the reflected light quantity of the recording/reproducing light beam. In other words, the end layer detection unit 41 can be determined that the focal point of the recording/reproducing light beam is in the servo layer if the address information cannot be read.

In Embodiment 2, the servo layer is disposed in the top layer of the optical disk 1, but the present invention is not limited to this configuration, and the servo layer may be disposed in the bottom layer or in an intermediate layer.

In Embodiment 2, it is determined that there is a recording layer where the layer position information is not recorded depending on whether the focal point of the recording/reproducing light beam is in the servo layer or not, but the present invention is not limited to this configuration. The optical disk apparatus may generate a focus error signal in accordance with the displacement of the focal point of the recording/reproducing light beam with respect to the recording layer or the servo layer of the optical disk 1 when the focal point of the recording/reproducing light beam moves in the focusing direction. Then the optical disk apparatus may detect whether there is a layer in the moving destination based on the focus error signal while moving in the focusing direction, so that it is determined that there is a recording layer where the layer position information is not recorded if there is no layer in the moving destination.

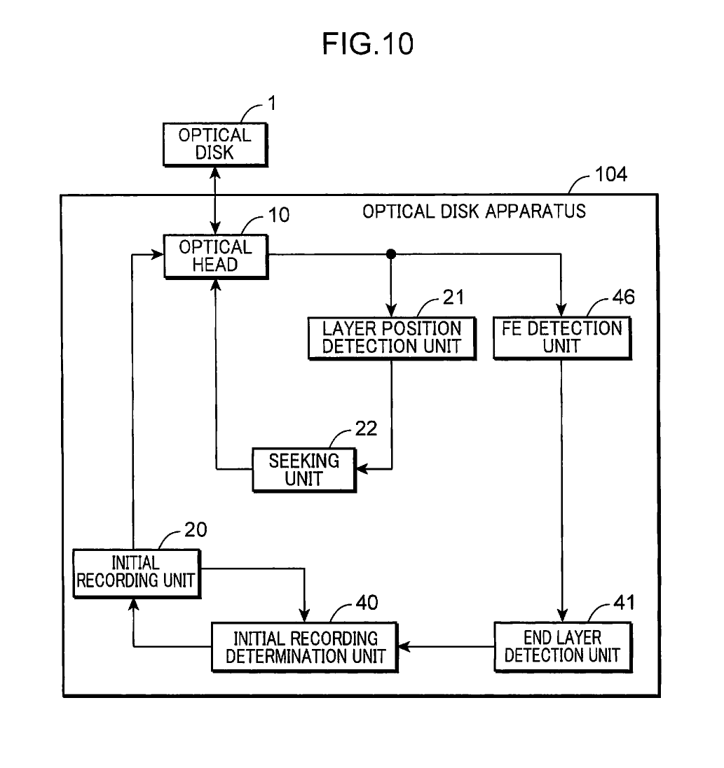

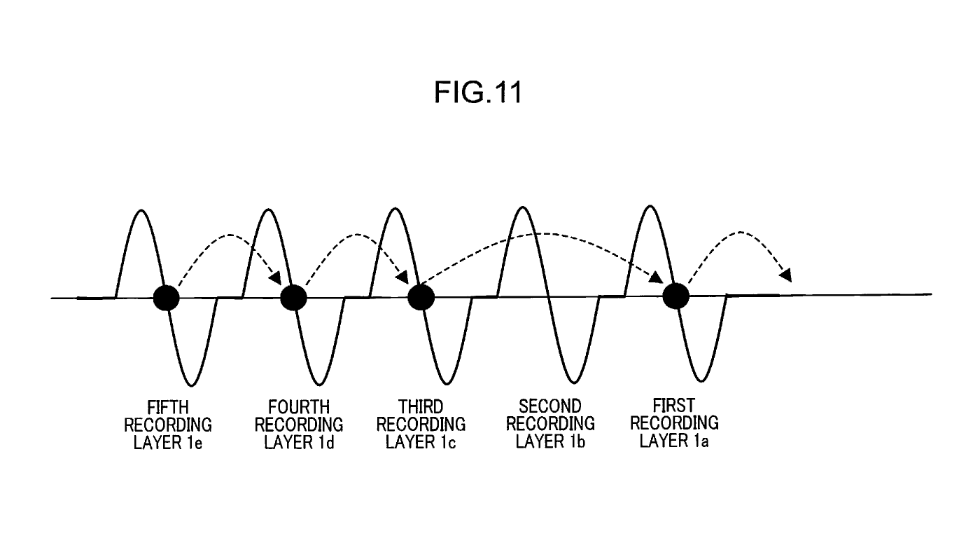

FIG. 10 is a block diagram depicting a configuration of an optical disk apparatus according to a modification of Embodiment 2 of the present invention. FIG. 11 is an example of a focus error signal detected by an FE detection unit and a moving pattern when the recording/reproducing light beam moves to another recording layer.

In FIG. 10, an optical disk apparatus 104 corresponds to an example of the optical information apparatus, an optical head 10 corresponds to an example of the focused irradiation unit, an initial recording unit 20 corresponds to an example of the layer position information recording unit, a layer position detection unit 21 corresponds to an example of the layer position detection unit, a seeking unit 22 corresponds to an example of the moving unit, an initial recording determination unit 40 corresponds to an example of the layer position information recording determination unit, an end layer detection unit 41 corresponds to an example of the end layer detection unit, and an FE detection unit 46 corresponds to an example of the focus error detection unit.

The optical disk apparatus 104 shown in FIG. 10 comprises the optical head 10, the initial recording unit 20, the layer position detection unit 21, the seeking unit 22, the initial recording determination unit 40, the end layer detection unit 41 and the FE detection unit 46. In FIG. 10, a composing element the same as a composing element of Embodiment 2 shown in FIG. 6 is denoted with a same reference number, for which description is omitted.

The FE detection unit 46 detects a displacement signal in accordance with a displacement of the focal point of the recording/reproducing light beam with respect to the plurality of recording layers or at least one servo layer of the optical disk 1.

Based on the displacement signal detected by the FE detection unit 46, the end layer detection unit 41 detects that the focal point of the recording/reproducing light beam exceeded an upper end recording layer or a lower end recording layer of the plurality of recording layers when the seeking unit 22 moves the focal point of the recording/reproducing light beam to a target recording layer.

Based on the light quantity signal received from the optical head 10, the FE detection unit 46 generates a focus error signal (hereafter called FE signal) in accordance with a displacement of the focal point of the recording/reproducing light beam in the focusing direction with respect to the recording layer or the servo layer of the optical disk 1, and transmits the generated FE signal to the end layer detection unit 41.

The end layer detection unit 41 determines whether there is a recording layer in the moving destination, based on the FE signal received from the FE detection unit 46. If there is not a recording layer in the moving destination, the end layer detection unit 41 determines that the focal point of the recording/reproducing light beam exceeded the upper end recording layer or the lower end recording layer of the plurality of recording layers, and transmits the determination result to the initial recording determination unit 40.

As FIG. 11 shows, the optical head 10 moves the focal point of the recording/reproducing light beam sequentially from the fifth recording layer 1e to the first recording layer 1a. In the initial recording operation, the layer position information is sequentially recorded from the fifth recording layer 1e to the first recording layer 1a.

In the stage of the initial recording operation there is a recording layer where the layer position information is not recorded, hence in some cases, the layer position information cannot be acquired from the layer position detection unit 21. This means that when the focal point of the recording/reproducing light beam is moved from the third recording layer 1c to the second recording layer 1b, for example, the initial recording unit 20 may move the focal point from the third recording layer 1c to the first recording layer 1a in error. In this case, the initial recording unit 20 records the layer position information that indicates the second recording layer 1b in the first recording layer 1a. Then the initial recording unit 20 moves the focal point of the recording/reproducing light beam to the front surface side of the optical disk 1, so that the focal point of the recording/reproducing light beam will move to the first recording layer 1a.

The FE detection unit 46 detects an FE signal while the focal point of the recording/reproducing light beam moves from the fifth recording layer 1e to the first recording layer 1a. The end layer detection unit 41 detects a zero cross point of the FE signal received from the FE detection unit 46, and if the zero cross point is detected, the end layer detection unit 41 determines that there is a recoding layer. A black dot in FIG. 11 indicates a detected recording layer. In FIG. 11, after the zero cross point corresponding to the first recording layer 1a is detected, a zero cross point is not detected even if the focal point of the recording/reproducing light beam is moved since there is no more recording layer. Then the end layer detection unit 41 determines that the focal point of the recording/reproducing light beam exceeded the lower end recording layer of the plurality of recording layers, since there is no recording layer in the moving destination.

As shown in FIG. 11, when the initial recording operation is performed, the layer position information is recorded not in the third recording layer 1c but in the first recording layer 1a, and the focal point of the recording/reproducing light beam exceeds the first recording layer 1a. If a number of recording layers, where the layer position information is recorded by the time the first recording layer 1a is exceeded, is four, it is determined that there is a recording layer where the layer position information is not recorded. By sequentially seeking whether the layer position information is recorded or not for the fifth recording layer 1e to the first recording layer 1a, the initial recording unit 20 can detect that the second recording layer 1b is in an unrecorded state. Hence the initial recording unit 20 records the layer position information again in the second recording layer 1b.

In this case, in the stage of recording the layer position information in the first recording layer 1a, the layer position information that indicates the second recording layer 1b is recorded in the first recording layer 1a. Therefore if the layer position information that indicates the second recording layer 1b is used again in the stage of recording the layer position information in the second recording layer 1b, the same layer position information is recorded in the two recording layers. To prevent this, the initial recording unit 20 records the layer position information that indicates the first recording layer 1a, which is not in use, when the layer position information is recorded in the second recording layer 1b again.

The configuration of the optical disk apparatus for moving the recording/reproducing light beam is the same as the configuration of the optical disk apparatus shown in FIG. 7, hence description thereof is omitted.

As mentioned above, the recording state determination unit 45 may determine that there is a recording layer where the layer position information is not recorded, by determining, after recording of the layer position information ends, whether the layer position information is recorded or not for all the recording layers recorded in the initial recording operation. In Embodiment 2, the optical disk apparatus 102 may not include the recording state determination unit 45.

In Embodiment 2, the initial recording determination unit 40 determines abnormality of the initial recording operation by determining whether there is a recording layer where the layer position information is not recorded in the initial recording operation, but the present invention is not limited to this configuration. The initial recording determination unit 40 may detect for each recording layer whether the layer position information has been recorded before recording the layer position information in the initial recording operation, and determine that the initial recording operation is abnormal if the layer position information has already been recorded.

In Embodiment 2, displacement in the recorded layer position information is corrected during the seeking operation by the recording/reproducing light beam after the layer position information is recorded again only in a recording layer where the layer position information is not recorded in the initial recording operation, but the present invention is not limited to this configuration. The displacement in the layer position information may be cancelled by recording the position information again for a recording layer as well where the layer position information, which is different from the original position of the recording layer, is recorded.

In Embodiment 2, the initial recording determination unit 40 detects that an abnormality occurred to the movement of the recording/reproducing light beam in the focusing direction when the initial recording operation was performed, but an abnormality that occurred in the movement of the recording/reproducing light beam in the focusing direction may be detected by the recording/reproducing light beam reaching the servo layer, for example, even in a normal moving operation of the recording/reproducing light beam.

### Embodiment 3

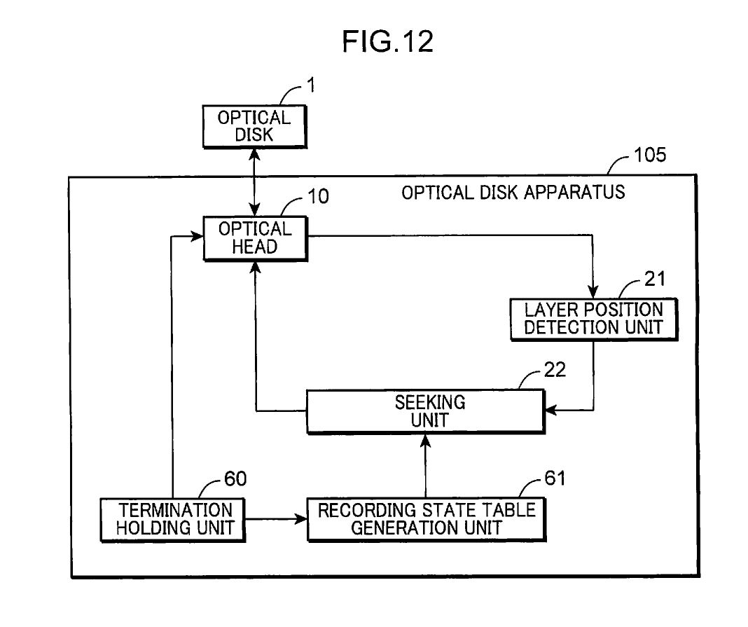

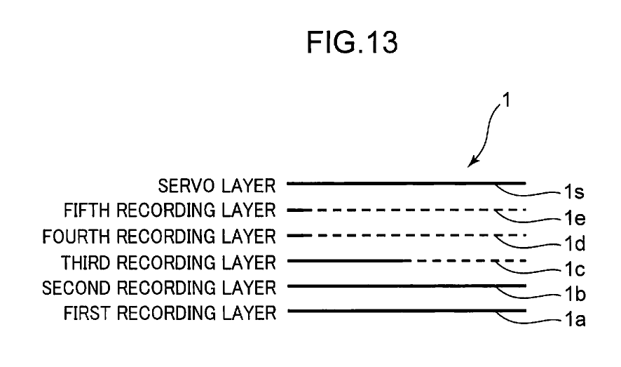

An operation of an optical disk apparatus according to Embodiment 3 will now be described with reference to FIG. 12 and FIG. 13. FIG. 12 is a block diagram depicting a configuration of the optical disk apparatus according to Embodiment 3 of the present invention. FIG. 13 is an example of a recording state of each recording layer of an optical disk 1.

In FIG. 12, an optical disk apparatus 105 corresponds to an example of the optical information apparatus, an optical head 10 corresponds to an example of the focused irradiation unit, a layer position detection unit 21 corresponds to an example of the layer position detection unit, a seeking unit 22 corresponds to an example of the moving unit, a termination holding unit 60 corresponds to an example of the termination position information holding unit, and a recording state table generation unit 61 corresponds to an example of the recording state information generation unit.

In FIG. 12, a composing element the same as a composing element of Embodiment 1 shown in FIG. 1 is denoted with a same reference number, for which description is omitted.

The optical disk apparatus 105 shown in FIG. 12 comprises the optical head 10, the layer position detection unit 21, the seeking unit 22, the termination holding unit 60 and the recording state table generation unit 61.

The termination holding unit 60 holds the termination position information that indicates the termination position of the user data recorded in the optical disk 1. The termination holding unit 60 holds the termination position information in association with the identification information that identifies the optical disk 1.

The recording state table generation unit 61 generates the recording state information that indicates the recording state of each recording layer in the radius position where the focal point of the recording/reproducing light beam is positioned, based on the termination position information held in the termination holding unit 60.

The seeking unit 22 determines the moving direction of the focal point of the recording/reproducing light beam in the focusing direction based on the recording state information generated by the recording state table generation unit 61, if the recording layer, where the focal point of the recording/reproducing light beam is positioned, is in an unrecorded state, and the layer position detection unit 21 cannot read the layer position information.

The termination holding unit 60 holds termination address information (termination position information) that indicates the termination address of the user data recorded on the optical disk 1, and transmits this information to the recording state table generation unit 61. The termination holding unit 60 updates the termination address information every time the user data is recorded. Based on the termination address information from the termination holding unit 60, the recording state table generation unit 61 generates the recording state table that indicates the recording state of each recording layer, and transmits this table to the seeking unit 22. If the layer position information cannot be acquired from the layer position detection unit 21, the seeking unit 22 determines the moving direction of the focusing direction for the focal point of the recording/reproducing light beam based on the recording state table received from the recording state table generation unit 61.

The user data is sequentially recorded from the upper end recording layer or the lower end recording layer of the plurality of recording layers of the optical disk 1. The recording state table generation unit 61 determines the recording state of each recording layer based on the termination address information held in the termination holding unit 60.

In FIG. 13, the solid line indicates a recorded area, and the dotted line indicates an unrecorded area. To record user data, it is assumed that the user data is recorded sequentially from the first recording layer 1a one-by-one. In this case, if half of the capacity of the optical disk 1 is used, the first recording layer 1a and the second recording layer 1b are all recorded, and the third recording layer 1c is recorded half way.

In this case, the termination holding unit 60 holds termination address information that indicates the last address of the recorded user data on the optical disk 1. Using this information, the recording state table generation unit 61 generates a recording state table that indicates, for example, the first recording layer 1a, the second recording layer 1b and the third recording layer 1c are recorded, and the fourth recording layer 1d and the fifth recording layer 1e are not recorded on the slightly inner radius side from the intermediate radius. The recording state table corresponds each recording layer and the recording state that indicates whether the recording layer is recorded or not.

On the slightly inner radius sider from the intermediate radius, the seeking unit 22 can acquire the layer position information from the layer position detection unit 21 to move the focal point of the recording/reproducing light beam in the focus direction, if the focal point of the recording/reproducing light beam is in the first recording layer 1a, the second recording layer 1b and the third recording layer 1c. Therefore the seeking unit 22 can calculate the moving direction or the moving distance of the focal point of the recording/reproducing light beam.

If the focal point of the recording/reproducing light beam is in the fourth recording layer 1d and the fifth recording layer 1e, on the other hand, the seeking unit 22 cannot acquire the layer position information from the layer position detection unit 21. Therefore if the recording layer, on which the recording/reproducing light beam is focused, is in an unrecorded state, the seeking unit 22 uses the recording state table received from the recording state table generation unit 61, and determines that the focal point of the recording/reproducing light beam is in the fourth recording layer 1d or the fifth recording layer 1e. Then the seeking unit 22 can allow the focal point of the recording/reproducing light beam to reach the third recording layer 1c by moving the focal point of the recording/reproducing light beam downward. In this embodiment, it is assumed that the user data is sequentially recorded. Therefore in the radius position slightly inner radius side from the intermediate radius, the focal point of the recording/reproducing light beam never moves to the fourth recording layer 1d or the fifth recording layer 1e, which are in an unrecorded state, as a target recording layer.

In this way, a table to indicate the recorded layers in the recorded state with respect to the radius position is generated in the optical disk 1, where the layer position information cannot be acquired because the user data is not recorded, thereby the focal position of the recording/reproducing light beam can be moved stably at high-speed.

In Embodiment 3, the termination holding unit 60 holds the final address information of the user data which was sequentially recorded from the upper end recording layer or the lower end recording layer of the plurality of recording layers of the optical disk 1, but the present invention is not limited to this configuration, and the final address information for each recording layer may be held. In other words, the termination holding unit 60 may hold the termination address information for each recording layer respectively, and the recording state table generation unit 61 may determine the recording state of each recording layer based on the termination address information of each recording layer held in the termination holding unit 60.

In Embodiment 3, the termination holding unit 60 continuously holds the already recorded final address information, but the present invention is not limited to this configuration. The optical head 10 may read the already recorded final address information from the optical disk 1 when the optical disk apparatus 105 starts up the optical disk 1, and store the final address information in the termination holding unit 60. In this case, the optical head 10 may record the final address information in the optical disk 1 when the reproduction address information is updated by recording the user data or when the optical disk apparatus 105 stops the optical disk 1.

### Embodiment 4

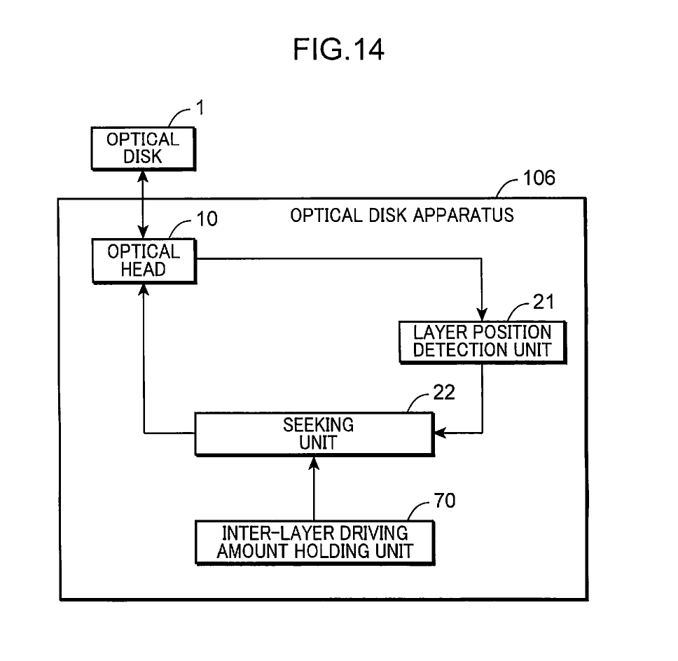

An operation of an optical disk apparatus according to Embodiment 4 of the present invention will now be described with reference to FIG. 14. FIG. 14 is a block diagram depicting a configuration of the optical disk apparatus according to Embodiment 4 of the present invention.

In FIG. 14, an optical disk apparatus 106 corresponds to an example of the optical information apparatus, an optical head 10 corresponds to an example of the focused irradiation unit, a layer position detection unit 21 corresponds to an example of the layer position detection unit, a seeking unit 22 corresponds to an example of the moving unit, and the inter-layer driving amount holding unit 70 corresponds to an example of the inter-layer driving amount holding unit.

In FIG. 14, a composing element the same as a composing element of Embodiment 1 shown in FIG. 1 is denoted with a same reference number, for which description is omitted.

The optical disk apparatus 106 shown in FIG. 14 comprises the optical head 10, the layer position detection unit 21, the seeking unit 22 and the inter-layer driving amount holding unit 70. The optical disk apparatus 106 may include the initial recording unit 20.

The inter-layer driving amount holding unit 70 holds the driving amount for controlling the distance between the focal point of the servo light beam and the focal point of the recording/reproducing light beam according to the distance between the servo layer and at least one recording layer of the plurality of recording layers. The inter-layer driving amount holding unit 70 holds the driving amount based on the pre-designed distance between the servo layer and each recording layer of the optical disk 1.

The seeking unit 22 moves the focal point of the recording/reproducing light beam according to the driving amount held in the inter-layer driving amount holding unit 70 if position control of the focal point of the servo light beam and the focal point of the recording/reproducing light beam in a direction perpendicular to the recording surface of the optical disk 1 is not performed.

The inter-layer driving amount holding unit 70 transmits a driving amount, according to the pre-designed distance between the recording layer and the servo layer, to the seeking unit 22. In the case when an abnormality is generated in the focusing control and the focus is locked in again, the seeking unit 22 drives the optical head 10 based on the driving amount received from the inter-layer driving amount holding unit 70, so that the distance between the focal point of the servo light beam and the focal point of the recording/reproducing light beam becomes a predetermined distance.

In other words, the inter-layer driving amount holding unit 70 holds a driving amount of an objective lens actuator and a collimate lens actuator included in the optical head 10. The objective lens actuator moves an objective lens in the optical axis direction, and moves the focal point of the recording/reproducing light beam to a target recording layer. The collimate lens actuator moves a second collimate lens in the optical axis direction, and moves the focal point of the servo light beam to the servo layer.

For example, the seeking unit 22 detects that a position control (focusing control) of the focal point of the servo light beam and the focal point of the recording/reproducing light beam in a direction perpendicular to the recording surface of the optical disk 1 has not been performed. In this case, the seeking unit 22 locks the focal point of the servo light beam in the servo layer, and moves the focal point of the recording/reproducing light beam to a predetermined reference position. The inter-layer driving amount holding unit 70 holds the driving amount of the optical head 10 for the focal point of the recording/reproducing light beam to move from the reference position in accordance with the distance between the servo layer and each recording layer. In other words, the inter-layer driving amount holding unit 70 holds the driving amount of the optical head 10 in accordance with the distance between the reference position and each recording layer, in association with each recording layer.

The seeking unit 22 moves the focal point of the recording/reproducing light beam from the reference position in accordance with the driving amount, which is held in the inter-layer driving amount holding unit 70 in association with the target recording layer.

In the seeking operation of the focal point of the recording/reproducing light beam in the initial recording operation, or in the normal seeking operation of the focal point of the recording/reproducing light beam, an abnormality may occur during focusing control, making focusing uncontrollable. When the focal point of the servo light beam is locked in the servo layer in such a case, the distance between the focal point of the recording/reproducing light beam to the focal point of the servo light beam is controlled using a pre-designed driving amount for the focal point of the recording/reproducing light beam to move to the target recording layer, that is held in the inter-layer driving amount holding unit 70. Thereby the time required for focus lock in operation for the focal point of the recording/reproducing light beam to the recording layer can be decreased.

In this way, focusing control can be restored at high-speed, even if the focusing control is disabled during the seeking operation of the focal point of the recording/reproducing light beam.

In Embodiment 4, the focal point of the recording/reproducing light beam is positioned in the target recording layer to restore the control of the focusing direction, but the present invention is not limited to this configuration. For example, the seeking unit 22 may drive the focal point of the recording/reproducing light beam so as to be positioned in a recording layer where the focal point was positioned immediately before the focusing control was disabled. Alternatively, the seeking unit 22 may drive the focal point of the recording/reproducing light beam so as to be positioned in one of the plurality of recording layers, such as the first recording layer 1a.

In Embodiment 4, the inter-layer driving amount holding unit 70 holds a driving amount of the optical head 10 for moving the focal point of the recording/reproducing light beam from the reference position in accordance with the distance between the servo layer and each recording layer, but the present invention is not limited to this, and may hold a moving distance of the focal point of the recording/reproducing light beam for moving the focal point of the recording/reproducing light beam from the reference position in accordance with the distance between the servo layer and each recording layer.

In Embodiment 4, the seeking unit 22 controls the distance between the focal point of the recording/reproducing light beam and the focal point of the servo light bean using the pre-designed driving amount that is held in the inter-layer driving amount holding unit 70, but the driving amount when the recording/reproducing light beam is actually focused on each recording layer may be measured so that this measured driving amount is held in the inter-layer driving amount holding unit 70. In other words, when the focal point of the recording/reproducing light beam is being focused and irradiated onto each recording layer, the inter-layer driving amount holding unit 70 may measure the driving amount for controlling the distance between the focal point of the servo light beam and the focal point of the recording/reproducing light beam on each recording layer, and holds the measured driving amount.

The above mentioned embodiments primarily reflect inventions having the following configurations.

An optical information apparatus according to an aspect of the present invention is an optical information apparatus for recording or reproducing information to/from an information carrier provided with a plurality of recording layers on which information is recorded and at least one servo layer which is used for servo control, this apparatus comprising: a focused irradiation unit that focuses and irradiates a servo light beam onto at least one servo layer, and focuses and irradiates a recording/reproducing light beam onto the plurality of recording layers; a layer position information recording unit that records layer position information for specifying a position of each recording layer in a predetermined position of each recording layer in advance before recording user data, in use of the recording/reproducing light beam which is focused and irradiated by the focused irradiation unit; a layer position detection unit that reads the layer position information recorded by the layer position information recording unit in a predetermined recording layer by using the recording/reproducing light beam, and detects, based on the read layer position information, which one of the plurality of recording layers is the predetermined recording layer where the focal point of the recording/reproducing light beam is positioned; and a moving unit that moves the focal point of the recording/reproducing light beam to a target position based on the layer position detected by the layer position detection unit.

According to this configuration, the focused irradiation unit focuses and irradiates a servo light beam onto at least one servo layer, and focuses and irradiates a recording/reproducing light beam onto the plurality of recording layers. The layer position information recording unit records the layer position information for specifying a position of each recording layer in a predetermined position of each recording layer in advance before recording the user data, using the recording/reproducing light beam which is focused and irradiated by the focused irradiation unit. The layer position detection unit reads the layer position information recorded by the layer position information recording unit in a predetermined recording layer, using the recording/reproducing light beam, and detects, based on the read layer position information, which one of the plurality of recording layers is the predetermined recording layer, where the focal point of the recording/reproducing light beam is positioned. The moving unit moves the focal point of the recording/reproducing light beam to a target position based on the layer position detected by the layer position detection unit.

Therefore the layer position information for specifying a position of each recording layer is recorded in a predetermined position of each recording layer in advance before recording the user data, then based on the recorded layer position information, it is detected which one of the plurality of recording layers is the predetermined recording layer, where the focal point of the recording/reproducing light beam is positioned, and based on the detected layer position, the focal point of the recording/reproducing light beam is moved to the target position. Therefore the focal point of the recording/reproducing light beam can be moved from the current recording layer to the target recording layer stably at high-speed.

It is preferable that this optical information apparatus further comprises a radius position error detection unit that detects an error of a position of the recording/reproducing light beam in the radius direction, wherein the layer position information recording unit determines a width in a tracking direction of the recording area for recording the layer position information in the predetermined position of each recording layer in advance, based on the error detected by the radius position error detection unit.

According to this configuration, an error of a position of the recording/reproducing light beam in the radius position is detected, and based on the detected error, a width in the tracking direction of the recording area for recording the layer position information in the predetermined position of each recording layer in advance, is determined.

Therefore even if the focal point of the recording/reproducing light beam is displaced in the radius direction, the layer position information can be detected with certainty.

It is preferable that this optical information apparatus further comprises a mechanical error amount holding unit that holds a mechanical error amount in the radius direction, which is generated when the focal point of the recording/reproducing light beam is moved in the radius direction, wherein the radius position error detection unit detects an error of the position of the recording/reproducing light beam in the radius direction based on the error amount held in the mechanical error amount holding unit.

According to this configuration, a mechanical error amount in the radius direction, which is generated when the focal point of the recording/reproducing light beam is moved in the radius direction, is held in the mechanical error amount holding unit. Based on an error amount held in the mechanical error amount holding unit, an error of a position of the recording/reproducing light beam in the radius direction is detected.

Therefore even if a mechanical displacement in the radius direction, which is generated upon moving the focal point of the recording/reproducing light beam in the radius direction, is actually generated, the layer position information can be detected with certainty.

It is preferable that this optical information apparatus further comprises a tilt radius error amount holding unit that holds an error amount of the focal point of the recording/reproducing light beam in the radius direction, which is generated by a relative tilt between an optical axis of the recording/reproducing light beam, which is parallel with the optical axis of the servo light beam, and the information carrier, in a state where the focal point of the servo light beam is controlled to be positioned on a predetermined track of the servo layer, wherein the radius position error detection unit detects an error of the position of the recording/reproducing light beam in the radius direction based on the error amount held in the tilt radius error amount holding unit.

According to this configuration, the tilt radius error amount holding unit holds an error amount of the focal point of the recording/reproducing light beam in the radius direction, which is generated by a relative tilt between the optical axis of the recording/reproducing light beam, which is parallel with the optical axis of the servo light beam, and the information carrier, in the state where the focal point of the servo light beam is controlled to be positioned on a predetermined track of the servo layer. Then an error of the position of the recording/reproducing light beam in the radius direction is detected based on the error amount held in the tilt radius error amount holding unit.

Therefore even if a relative tilt is generated between the optical axis of the recording/reproducing light beam, which is parallel with the optical axis of the servo light beam, and the information carrier, the layer position information can be detected with certainty.

In this optical information apparatus, it is preferable that the radius position error detection unit detects an error of a position of the recording/reproducing light beam in the radius direction that is common to all the recording layers.

According to this configuration, an error of a position of the recording/reproducing light beam in the radius direction, that is common to all the recording layers, is detected, hence there is no need to detect an error for each recording layer, and the error detection processing can be simplified.

In this optical information apparatus, it is preferable that the radius position error detection unit detects an error of a position of the recording/reproducing light beam in the radius direction for each recording layer.

According to this configuration, an error of a position of the recording/reproducing light beam in the radius direction is detected for each recording layer, hence a more accurate error can be detected, and the focal point of the recording/reproducing light beam can be moved with more certainty from the current recording layer to the target recording layer.

In this optical information apparatus, it is preferable that the layer position information recording unit records the layer position information in advance in a same radius position in each recording layer.

According to this configuration, the layer position information is recorded in advance in a same radius position in each recording layer, hence when the focal point of the recording/reproducing light beam moves in the focusing direction, the focal point can be moved stably while recognizing the current position with certainty.

It is preferable that this optical information apparatus further comprises a layer position information recording determination unit that determines whether there is a recording layer where the layer position information is not recorded by the layer position information recording unit, wherein when the layer position information recording determination unit determines that there is a recording layer where the layer position information is not recorded, the layer position information recording unit records the layer position information in a predetermined position of the recording layer where the layer position information is not recorded.

According to this configuration, it is determined whether there is a recording layer where the layer position information is not recorded. If it is determined that there is a recording layer where the layer position information is not recorded, the layer position information is recorded again in a predetermined position of the recording layer where the layer position information is not recorded. Hence the layer position information can be recorded in all the recording layer with certainty.

It is preferable that this optical information apparatus further comprises an end layer detection unit that detects that the focal point of the recording/reproducing light beam has exceeded an upper end recording layer or a lower end recording layer of the plurality of recording layers, wherein when the layer position information recording unit records the layer position information in the upper end recording layer or the lower end recording layer, the layer position information recording determination unit determines that there is a recording layer where the layer position information is not recorded in a case where the end layer detection unit detects that the focal point of the recording/reproducing light beam exceeded the upper end recording layer or the lower end recording layer of the plurality of recording layers before reaching the target recording layer.

According to this configuration, it is detected that the focal point of the recording/reproducing light beam exceeded an upper end recording layer or a lower end recording layer of the plurality of recording layers. When the layer position information is recorded in the upper end recording layer or the lower end recording layer, it is determined that there is a recording layer where the layer position information is not recorded if it is detected that the focal point of the recording/reproducing light beam exceeded the upper end recording layer or the lower end recording layer of the plurality of recording layers before reaching the target recording layer.

Hence it can easily be determined whether there is a recording layer where the layer position information is not recorded by detecting that the focal point of the recording/reproducing light beam exceeded the upper end recording layer or the lower end recording layer of the plurality of recording layers before reaching the target recording layer.

It is preferable that this optical information apparatus further comprises a focus error detection unit that detects a displacement signal in accordance with a displacement of a focal point of the recording/reproducing light beam with respect to the plurality of recording layers or at least one servo layer of the information carrier, wherein when the focal point of the recording/reproducing light beam is moved to a target recording layer by the moving unit, the end layer detection unit detects that the focal point of the recording/reproducing light beam has exceeded the upper end recording layer or the lower end recording layer of the plurality of recording layers, based on the displacement signal detected by the focus error detection unit.

According to this configuration, a displacement signal, in accordance with a displacement of a focal point of the recording/reproducing light beam with respect to the plurality of recording layer or at least one servo layer of the information carrier, is detected. Then when the focal point of the recording/reproducing light beam is moved to a target recording layer, it is detected that the focal point of the recording/reproducing light beam exceeded the upper end recording layer or the lower end recording layer of the plurality of recording layers based on the detected displacement signal.

Hence it can be easily detected that the focal point of the recording/reproducing light beam exceeded the upper end recording layer or the lower end recording layer of the plurality of recording layers, based on the displacement signal in accordance with the displacement of the focal point of the recording/reproducing light beam.

It is preferable that this optical information apparatus further comprises a servo layer determination unit that determines whether the focal point of the recording/reproducing light beam is in the recording layer or the servo layer based on a reflected light quantity, wherein if the servo layer determination unit determined that the focal point of the recording/reproducing light beam is in the servo layer, the end layer detection unit detects that the focal point of the recording/reproducing light beam has exceeded the upper end recording layer or the lower end recording layer of the plurality of recording layers.

According to this configuration, it is determined whether the focal point of the recording/reproducing light beam is in the recording layer or the servo layer based on the reflected light quantity. If it is determined that the focal point of the recording/reproducing light beam is in the servo layer, it is detected whether the focal point of the recording/reproducing light beam exceeded the upper end recording layer or the lower end recording layer of the plurality of recording layers.

Hence it can easily be detected whether the focal point of the recording/reproducing light beam exceeded the upper end recording layer or the lower end recording layer of the plurality of recording layers by determining whether the focal point of the recording/reproducing light beam is in the recording layer or the servo layer.

It is preferable that this optical information apparatus further comprises a recording state determination unit that focuses and irradiates the recording/reproducing light beam on all of the plurality of recording layers respectively after the layer position information recording unit records the layer position information in each recording layer in advance, and determines whether each recording layer is in a recorded state or an unrecorded state based on the reflected light quantity received from each recording layer, wherein when the recording state determination unit determines that at least one recording layer is in an unrecorded state, the layer position information recording determination unit determines that there is a recording layer where the layer position information is not recorded.

According to this configuration, the recording/reproducing light beam is focused and irradiated onto all of the plurality of recording layers respectively after the layer position information is recorded in each recording layer in advance, and it is determined whether each recording layer is in a recorded state or an unrecorded state based on the reflected light quantity received from each recording layer. If it is determined that at least one recording layer is in an unrecorded state, it is determined that there is a recording layer where the layer position information is not recorded.

Since the recording/reproducing light beam is focused and irradiated onto all of the plurality of recording layers respectively after the layer position information is recorded in each recording layer in advance, and it is determined whether each recording layer is in a recorded state or an unrecorded state based on the reflected light quantity received from each recording layer, a recording layer where the layer position information is not recorded can be detected with certainty.

It is preferable that this optical information apparatus further comprises: a layer position reading unit that reads the layer position information recorded in each recording layer by the layer position information recording unit; and a layer position conversion information generation unit that generates layer position conversion information in which layer position information read by the layer position reading unit and an actual position of the recording layer are associated with each other, wherein the moving unit converts the layer position information detected by the layer position detection unit into the actual recording layer position by using the layer position conversion information generated by the layer position conversion information generation unit, and moves the focal point of the recording/reproducing light beam to the target recording layer.

According to this configuration, the layer position information recorded in each recording layer is read. Then the layer position conversion information, in which the read layer position information and an actual position of the recording layer are corresponded, is generated. Using the generated layer position conversion information, the detected layer position information is converted into an actual position of the recording layer, and the focal point of the recording/reproducing light beam is moved to the target recording layer.

Therefore even if the layer position information is recorded with a position which is different from the actual position of the recording layer, the focal point of the recording/reproducing light beam can be moved to the target recording layer.

In this optical information apparatus, it is preferable that the moving unit moves the focal point of the recording/reproducing light beam to the target recording layer in a radius position where the layer position information is recorded by the layer position information recording unit.

According to this configuration, the focal point of the recording/reproducing light beam is moved to the target recording layer in a radius position where the layer position information is recorded, hence the focal point of the recording/reproducing light beam can be stably moved in the focusing direction, while recognizing the current position thereof with certainty.

In this optical information apparatus, it is preferable that the layer position information recording unit records in advance the layer position information in a plurality of radius positions of each recording layer.

According to this configuration, the layer position information is recorded in advance in a plurality of radius positions of each recording layer, hence the time for the focal point of the recording/reproducing light beam to reach the position where the layer position information is recorded can be decreased.

It is preferable that this optical information apparatus further comprises: a termination position information holding unit that holds termination position information that indicates a termination position of user data recorded in the information carrier; and a recording state information generation unit that generates, based on the termination position information held in the termination position information holding unit, recording state information that indicates a recording state of each recording layer in a radius position where the focal point of the recording/reproducing light beam is positioned, wherein when the recording layer, where the focal point of the recording/reproducing light beam is positioned, is in an unrecorded state and the layer position detection unit cannot read the layer position information, the moving unit determines the direction to move the focusing direction of the focal point of the recording/reproducing light beam based on the recording state information generated by the recording state information generation unit.

According to this configuration, the termination position information holding unit holds the termination position information that indicates a termination position of user data recorded in the information carrier. Based on the termination position information held in the termination position information holding unit, the recording state information, that indicates a recording state of each recording layer in a radius position where the focal point of the recording/replacing light beam is positioned, is generated. If the recording layer where the focal point of the recording/reproducing light beam is positioned is an unrecorded state and the layer position information cannot be read, the direction to move the focusing direction of the focal point of the recording/reproducing light beam is determined based on the recording state information.

Hence even if the recording layer where the focal point of the recording/reproducing light beam is positioned is in an unrecorded state and the layer position information cannot be read, the focal point of the recording/reproducing light beam can be moved with certainty.

In this optical information apparatus, it is preferable that the user data is recorded sequentially from the upper end recording layer or the lower end recording layer out of the plurality of recording layers of the information carrier, and the recording state information generation unit determines the recording state of each recording layer based on the termination position information held in the termination position holding unit.

According to this configuration, the user data is recorded sequentially from the upper end recording layer or the lower end recording layer out of the plurality of recording layers of the information carrier. Then the recording state of each recording layer is determined based on the termination position information held in the termination position holding unit.

Since the sequence of the recording layers in which the user data is recorded is predetermined and the recording state of each recording layer is determined, the focal point of the recording/reproducing light beam can be moved with certainty.

In this optical information apparatus, it is preferable that the termination position holding unit holds the termination position information for each recording layer, and the recording state information generation unit determines the recording state of each recording layer based on the termination position information of each recording layer held in the termination position holding unit.

According to this configuration, the termination position information is held for each recording layer respectively. Then the recording state of each recording layer is determined based on the termination position information of each recording layer held in the termination position holding unit. Since the recording state of each recording layer is determined, the focal point of the recording/reproducing light beam can be moved with certainty.

It is preferable that this optical information apparatus further comprises an inter-layer driving amount holding unit that holds a driving amount for controlling a distance between a focal point of the servo light beam and a focal point of the recording/reproducing light beam according to a distance between the servo layer and at least one of the plurality of recording layers, wherein when a position control of the focal point of the servo light beam and the focal point of the recording/reproducing light beam in the direction perpendicular to the recording surface of the information carrier is not performed, the moving unit moves the focal point of the recording/reproducing light beam according to the driving amount held in the inter-layer driving amount holding unit.

According to this configuration, the inter-layer driving amount holding unit holds a driving amount for controlling a distance between the focal point of the servo light beam and the focal point of the recording/reproducing light beam according to the distance between the servo layer and at least one of the plurality of recording layers. If the position control of the focal point of the servo light beam and the focal point of the recording/reproducing light beam in the direction perpendicular to the recording surface of the information carrier is not performed, the focal point of the recording/reproducing light beam is moved according to the driving amount held in the inter-layer driving amount holding unit.

Hence even if the position control of the focal point of the servo light beam and the focal point of the recording/reproducing light beam in the direction perpendicular to the recording surface of the information carrier is not performed, the position control in the focusing direction can be easily performed again based on the driving amount for controlling the distance between the focal point of the servo light beam and the focal point of the recording/reproducing light beam.

In this optical information apparatus, it is preferable that the inter-layer driving amount holding unit holds the driving amount based on the pre-designed distance between the servo layer and each recording layer of the information carrier.

According to this configuration, the driving amount based on the pre-designed distance between the servo layer and each recording layer of the information carrier is held, hence the position control in the focusing direction can be performed again using a simple configuration.

In this optical information apparatus, it is preferable that when the focal point of the recording/reproducing light beam is focused and irradiated onto each recording layer, the inter-layer driving amount holding unit measures a driving amount to control a distance between the focal point of the servo light beam and the focal point of the recording/reproducing light beam in each recording layer, and holds the measured driving amount.

According to this configuration, when the focal point of the recording/reproducing light beam is focused and irradiated onto each recording layer, the driving amount to control the distance between the focal point of the servo light beam and the focal point of the recording/reproducing light beam in each recording layer, is measured, and the measured driving amount is held. Hence the position control in the focusing direction can be performed again at higher accuracy.

In this optical information apparatus, it is preferable that the layer position information recording unit records the layer position information in the predetermined position of each recording layer in advance when the information carrier is shipped.

According to this configuration, the layer position information is recorded in the predetermined position of each recording layer in advance when the information carrier is shipped, hence the layer position information can be recorded in advance without making the startup time of the optical information apparatus long.

In this optical information apparatus, it is preferable that the layer position information recording unit records the layer position information in the predetermined position of each recording layer in advance when the information carrier is started up for the first time.

According to this configuration, the layer position information is recorded in the predetermined position of each recording layer in advance when the information carrier is started up for the first time, hence the layer position information can be recorded without extending the manufacturing process tact time of the optical information apparatus.

In this optical information apparatus, it is preferable that the layer position information recording unit records the layer position information in the predetermined position of each recording layer in advance when the user data is recorded on the information carrier for the first time.

According to this configuration, the layer position information is recorded in the predetermined position of each recording layer in advance when the user data is recorded on the information carrier for the first time, and the layer position information is not recorded unless the user data is recorded on the information carrier for the first time, hence the startup time of the optical information apparatus can be shortened.

In this optical information apparatus, it is preferable that the layer position information recording unit records the layer position information in the predetermined position of one recording layer out of the plurality of recording layers of the information carrier in advance when the user data is recorded on this one recording layer for the first time.

According to this configuration, the layer position information is recorded in the predetermined position of one recording layer out of the plurality of recording layers of the information carrier in advance when the user data is recorded on this one recording layer for the first time, hence the layer position information can be recorded only in the necessary recording layers, and the startup time of the optical information apparatus can therefore be shortened.

An information recording or reproducing method according to another aspect of the present invention is an information recording or reproducing method for recording or reproducing information to/from an information carrier provided with a plurality of recording layers on which information is recorded and at least one servo layer which is used for servo control, the method comprising: a layer position information recording step of recording layer position information for specifying a position of each recording layer in a predetermined position of each recording layer in advance before recording user data in use of a recording/reproducing light beam which is focused and irradiated onto the plurality of recording layers; a layer position detecting step of reading the layer position information recorded in the layer position information recording step in a predetermined recording layer by using the recording/reproducing light beam, and detecting, based on the read layer position information, which one of the plurality of recording layers is the predetermined recording layer where the focal point of the recording/reproducing light beam is positioned; and a moving step of moving the focal point of the recording/reproducing light beam to a target position based on the layer position detected in the layer position detecting step.

According to this configuration, in the layer position information recording step, the layer position information for specifying a position of each recording layer is recorded in advance in a predetermined position of each recording layer before recording the user data, using the recording/reproducing light beam which is focused and irradiated onto the plurality of recording layers. In the layer position detecting step, the layer position information recorded in the layer position information recording step in the predetermined recording layer is read using the recording/reproducing light beam, and based on the read layer position information, it is detected which one of the plurality of recording layers is the predetermined recording layer, where the focal point of the recording/reproducing light beam is positioned. In the moving step, the focal point of the recording/reproducing light beam is moved to the target position based on the layer position detected in the layer position detecting step.

Therefore the layer position information for specifying a position of each recording layer is recorded in a predetermined position of each recording layer in advance before recording the user data, then based on the recorded layer position information, it is detected which one of the plurality of recording layers is the predetermined recording layer, where the focal point of the recording/reproducing light beam is positioned, and based on the detected layer position, the focal point of the recording/reproducing light beam is moved to the target position. Therefore the focal point of the recording/reproducing light beam can be moved from the current recording layer to the target recording layer stably at high-speed.

The embodiments or examples described in “DESCRIPTION OF EMBODIMENTS” are merely to clarify the technical content of the present invention, and are not intended to limit the present invention to these embodiments alone, but can be modified and changed in various ways within the spirit of the present invention and the scope of the Claims.

### INDUSTRIAL APPLICABILITY

The optical information apparatus and the information recording or reproducing method according to the present invention can be applied to a seeking operation of a focal point of a recording/reproducing light beam on an information carrier that is provided with a servo layer and a plurality of recording layers. Therefore the present invention can be used for a large capacity optical disk recorder or a computer memory apparatus, for example, which are applied equipment of an optical information apparatus.

1. An optical information apparatus for recording or reproducing information to/from an information carrier provided with a plurality of recording layers on which information is recorded and at least one servo layer which is used for servo control,
the apparatus comprising:
a focused irradiation unit that focuses and irradiates a servo light beam onto at least one servo layer, and focuses and irradiates a recording/reproducing light beam onto the plurality of recording layers;
a layer position information recording unit that records layer position information for specifying a position of each recording layer in a predetermined position of each recording layer in advance before recording user data, in use of the recording/reproducing light beam which is focused and irradiated by the focused irradiation unit;
a layer position detection unit that reads the layer position information recorded by the layer position information recording unit in a predetermined recording layer by using the recording/reproducing light beam, and detects, based on the read layer position information, which one of the plurality of recording layers is the predetermined recording layer where the focal point of the recording/reproducing light beam is positioned; and
a moving unit that moves the focal point of the recording/reproducing light beam to a target position based on the layer position detected by the layer position detection unit.

2. The optical information apparatus according to claim 1, further comprising a radius position error detection unit that detects an error of a position of the recording/reproducing light beam in the radius direction, wherein
the layer position information recording unit determines a width in a tracking direction of the recording area for recording the layer position information in the predetermined position of each recording layer in advance, based on the error detected by the radius position error detection unit.

3. The optical information apparatus according to claim 2, further comprising a mechanical error amount holding unit that holds a mechanical error amount in the radius direction, which is generated when the focal point of the recording/reproducing light beam is moved in the radius direction, wherein
the radius position error detection unit detects an error of the position of the recording/reproducing light beam in the radius direction based on the error amount held in the mechanical error amount holding unit.

4. The optical information apparatus according to claim 2, further comprising a tilt radius error amount holding unit that holds an error amount of the focal point of the recording/reproducing light beam in the radius direction, which is generated by a relative tilt between an optical axis of the recording/reproducing light beam, which is parallel with the optical axis of the servo light beam, and the information carrier, in a state where the focal point of the servo light beam is controlled to be positioned on a predetermined track of the servo layer, wherein
the radius position error detection unit detects an error of the position of the recording/reproducing light beam in the radius direction based on the error amount held in the tilt radius error amount holding unit.

5. The optical information apparatus according to claim 2, wherein
the radius position error detection unit detects an error of a position of the recording/reproducing light beam in the radius direction that is common to all the recording layers.

6. The optical information apparatus according to claim 2, wherein
the radius position error detection unit detects an error of a position of the recording/reproducing light beam in the radius direction for each recording layer.

7. The optical information apparatus according to claim 1, wherein
the layer position information recording unit records the layer position information in advance in a same radius position in each recording layer.

8. The optical information apparatus according to claim 1, further comprising a layer position information recording determination unit that determines whether there is a recording layer where the layer position information is not recorded by the layer position information recording unit, wherein
when the layer position information recording determination unit determines that there is a recording layer where the layer position information is not recorded, the layer position information recording unit records the layer position information in a predetermined position of the recording layer where the layer position information is not recorded.

9. The optical information apparatus according to claim 8, further comprising an end layer detection unit that detects that the focal point of the recording/reproducing light beam has exceeded an upper end recording layer or a lower end recording layer of the plurality of recording layers, wherein
when the layer position information recording unit records the layer position information in the upper end recording layer or the lower end recording layer, the layer position information recording determination unit determines that there is a recording layer where the layer position information is not recorded in a case where the end layer detection unit detects that the focal point of the recording/reproducing light beam exceeded the upper end recording layer or the lower end recording layer of the plurality of recording layers before reaching the target recording layer.

10. The optical information apparatus according to claim 9, further comprising a focus error detection unit that detects a displacement signal in accordance with a displacement of a focal point of the recording/reproducing light beam with respect to the plurality of recording layers or at least one servo layer of the information carrier, wherein
when the focal point of the recording/reproducing light beam is moved to a target recording layer by the moving unit, the end layer detection unit detects that the focal point of the recording/reproducing light beam has exceeded the upper end recording layer or the lower end recording layer of the plurality of recording layers, based on the displacement signal detected by the focus error detection unit.

11. The optical information apparatus according to claim 9, further comprising a servo layer determination unit that determines whether the focal point of the recording/reproducing light beam is in the recording layer or the servo layer based on a reflected light quantity, wherein
when the servo layer determination unit determined that the focal point of the recording/reproducing light beam is in the servo layer, the end layer detection unit detects that the focal point of the recording/reproducing light beam has exceeded the upper end recording layer or the lower end recording layer of the plurality of recording layers.

12. The optical information apparatus according to claim 8, further comprising a recording state determination unit that focuses and irradiates the recording/reproducing light beam on all of the plurality of recording layers respectively after the layer position information recording unit records the layer position information in each recording layer in advance, and determines whether each recording layer is in a recorded state or an unrecorded state based on the reflected light quantity received from each recording layer, wherein
when the recording state determination unit determines that at least one recording layer is in an unrecorded state, the layer position information recording determination unit determines that there is a recording layer where the layer position information is not recorded.

13. The optical information apparatus according to claim 1, further comprising:
a layer position reading unit that reads the layer position information recorded in each recording layer by the layer position information recording unit; and
a layer position conversion information generation unit that generates layer position conversion information in which layer position information read by the layer position reading unit and an actual position of the recording layer are associated with each other, wherein
the moving unit converts the layer position information detected by the layer position detection unit into the actual recording layer position by using the layer position conversion information generated by the layer position conversion information generation unit, and moves the focal point of the recording/reproducing light beam to the target recording layer.

14. The optical information apparatus according to claim 7, wherein
the moving unit moves the focal point of the recording/reproducing light beam to the target recording layer in a radius position where the layer position information is recorded by the layer position information recording unit.

15. The optical information apparatus according to claim 14, wherein
the layer position information recording unit records in advance the layer position information in a plurality of radius positions of each recording layer.

16. The optical information apparatus according to claim 1, further comprising:
a termination position information holding unit that holds termination position information that indicates a termination position of user data recorded in the information carrier; and
a recording state information generation unit that generates, based on the termination position information held in the termination position information holding unit, recording state information that indicates a recording state of each recording layer in a radius position where the focal point of the recording/reproducing light beam is positioned, wherein
when the recording layer, where the focal point of the recording/reproducing light beam is positioned, is in an unrecorded state and the layer position detection unit cannot read the layer position information, the moving unit determines the direction to move the focusing direction of the focal point of the recording/reproducing light beam based on the recording state information generated by the recording state information generation unit.

17. The optical information apparatus according to claim 16, wherein
the user data is recorded sequentially from the upper end recording layer or the lower end recording layer out of the plurality of recording layers of the information carrier, and
the recording state information generation unit determines the recording state of each recording layer based on the termination position information held in the termination position holding unit.

18. The optical information apparatus according to claim 16, wherein
the termination position holding unit holds the termination position information for each recording layer, and
the recording state information generation unit determines the recording state of each recording layer based on the termination position information of each recording layer held in the termination position holding unit.

19. The optical information apparatus according to claim 1, further comprising an inter-layer driving amount holding unit that holds a driving amount for controlling a distance between a focal point of the servo light beam and a focal point of the recording/reproducing light beam according to a distance between the servo layer and at least one of the plurality of recording layers, wherein
when a position control of the focal point of the servo light beam and the focal point of the recording/reproducing light beam in the direction perpendicular to the recording surface of the information carrier is not performed, the moving unit moves the focal point of the recording/reproducing light beam according to the driving amount held in the inter-layer driving amount holding unit.

20. The optical information apparatus according to claim 19, wherein the inter-layer driving amount holding unit holds the driving amount based on the pre-designed distance between the servo layer and each recording layer of the information carrier.

21. The optical information apparatus according to claim 19, wherein
when the focal point of the recording/reproducing light beam is focused and irradiated onto each recording layer, the inter-layer driving amount holding unit measures a driving amount to control a distance between the focal point of the servo light beam and the focal point of the recording/reproducing light beam in each recording layer, and holds the measured driving amount.

22. The optical information apparatus according to claim 1, wherein
the layer position information recording unit records the layer position information in the predetermined position of each recording layer in advance when the information carrier is shipped.

23. The optical information apparatus according to claim 1, wherein
the layer position information recording unit records the layer position information in the predetermined position of each recording layer in advance when the information carrier is started up for the first time.

24. The optical information apparatus according to claim 1, wherein
the layer position information recording unit records the layer position information in the predetermined position of each recording layer in advance when the user data is recorded on the information carrier for the first time.

25. The optical information apparatus according to claim 1, wherein
the layer position information recording unit records the layer position information in the predetermined position of one recording layer out of the plurality of recording layers of the information carrier in advance when the user data is recorded on this one recording layer for the first time.

26. An information recording or reproducing method for recording or reproducing information to/from an information carrier provided with a plurality of recording layers on which information is recorded and at least one servo layer which is used for servo control,
the method comprising:
a layer position information recording step of recording layer position information for specifying a position of each recording layer in a predetermined position of each recording layer in advance before recording user data, in use of a recording/reproducing light beam which is focused and irradiated onto the plurality of recording layers;
a layer position detecting step of reading the layer position information recorded in the layer position information recording step in a predetermined recording layer by using the recording/reproducing light beam, and detecting, based on the read layer position information, which one of the plurality of recording layers is the predetermined recording layer where the focal point of the recording/reproducing light beam is positioned; and
a moving step of moving the focal point of the recording/reproducing light beam to a target position based on the layer position detected in the layer position detecting step.
